(19) United States
(12) Patent Application Publication
(10) Pub. No.: US 2005/0288950 A1
(43) Pub. Date: Dec. 29, 2005

(54) Litigation manager

(76) Inventor: Scott Mager, Ft. Lauderdale, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/124,727

(22) Filed: May 9, 2005

Related U.S. Application Data
(60) Provisional application No. 60/569,428, filed on May 7, 2004.

(51) Int. Cl. G06Q 99/00

(52) U.S. Cl. 705/1

(57) ABSTRACT

A system for managing a plurality of litigation cases includes a case management function, a reference library function, and a system administration function. The system further includes a computer program running on a server, a first network access device operated by a law firm or attorney, a second network access device operated by an insurance company or insurance company representative, and a third network access device operated by a systems administrator. The server and the network access devices are communicatively connected to a communications network such that the network access devices can access the computer program running on the server. The computer program encodes instructions for operating the system on the server.

### CROSS REFERENCE TO RELATED APPLICATION

The present application claims the priority of U.S. provisional patent application No. 60/569,428 filed May 7, 2004.

### FIELD OF THE INVENTION

The invention relates generally to the fields of law practice management and information technology. More particularly, the invention relates to a system and method for managing legal cases and assisting attorneys in preparing and defending cases.

### BACKGROUND

Tort litigation consumes billions of dollars each year. Individuals and businesses offset the risks associated with tort liability by obtaining insurance policies. In the event of a lawsuit or threat of a lawsuit, an insurance company will defend and indemnify the insured in accordance with the provisions of the insurance policy. To provide a defense for the insured, an insurance company will often engage an outside law firm to represent the insured against a plaintiff. As a consequence, insurance companies are typically involved in managing a large number of litigation cases. All too often, however, these cases are not properly and aggressively defended.

There are a number of reasons why litigation of tort cases is not handled in the most efficient fashion. Among these, there is a lack of information sharing among defense attorneys and law firms. This may be caused by competition for clients among different attorneys or firms and also the lack of an easy-to-use system for sharing information. Poor communication between an attorney and an insurance company, suboptimal organization, inadequate attorney training, and lack of consistency in how attorneys handle a given type of case can also make it difficult for an insurance company or law firm to efficiently and effectively manage a large caseload.

A need exists for a means to reduce the risk of adverse judgments and greatly reduce the settlements that are paid in these cases. A system that enhances the attorney's as well as the client's ability to obtain important and accurate information in a quick and efficient fashion would increase productivity and decrease costs. A system that links talented, trained lawyers and law firms and thereby allows them to share their skills, strategies and victories with one another would result in a pool of defense attorneys with increased skills, benefiting both the attorneys and their clients.

### SUMMARY

The invention relates to the development of a computer communications network-based system for managing a large volume of litigations. The system can be securely accessed by law firms, insurance companies, and system administrators over a communications network so that each of the foregoing can work together effectively and efficiently to manage a large number of cases. Information that can be accessed by a law firm or insurance company using the system of the invention include a list of cases handled by a user, a list of steps to be completed for each case, a list of due dates for each step, a calendaring function to show due dates, the estimated potential liability of a case, other information about a case, and links to forms, statutes, regulations, case law, and educational/training material relating to the subject matter of a case.

Because all information and materials required for handling a case or group of cases are readily at hand for a user of the system, the invention allows both law firm personnel (e.g., paralegals, attorneys, and supervising attorneys) and insurance company personnel (e.g., claims consultants, claims managers, and regional managers) to more easily and effectively handle a large number of litigations. The invention further provides an easy-to-use system for quickly identifying problems before they escalate. For example, attorneys who consistently fail to keep up with deadlines or claims consultants that are slow in disposing of cases can be identified. The increased efficiency and effectiveness provided by the system of the invention reduces the costs of defending a suit and also helps attorneys provide a better defense for clients.

Accordingly, the invention features a a system for managing a plurality of litigation cases (e.g., tort cases). The system features a case management function, a reference library function, and a system administration function, and is implemented by a computer program running on a server communicatively connected to a communications network (e.g., the Internet). The computer program encodes instructions for operating the system on the server. The system further includes a first network access device (e.g., a desktop or notebook computer) operated by a law firm or attorney and a second network access device operated by an insurance company or insurance company representative, wherein the first and second network access devices are communicatively connected to the communications network. The system can further feature a third network access device operated by a system administrator, the third network access device also being communicatively connected to the communications network.

The case management function can include a calendar function, a case list function, and/or a case report function. The reference library function can include a means to access statutes, case law, forms, and/or educational materials. The system administration function can include a means to add, delete, and/or modify information contained on the system, and can further include a user selection function, a content selection function, an event viewer function, a categories codes function, a type codes function, a status code function, a matrices function, and/or a matrix steps function.

In another aspect, the invention features a computer program running on a server accessible via a communications network by at least a first network access device operated by a law firm or attorney and a second network access device operated by an insurance company or insurance company representative. The computer program includes instructions for causing the server to operate a system for managing a plurality of litigation cases.

The invention further features a method for managing a plurality of litigation cases. The method of the invention includes the step of: running a computer program on a server, the computer program encoding instructions for operating a system for managing a plurality of litigation cases on the server.

As used herein, the phrase “computer communications network” means a group of two or more computer systems communicatively linked together. For example, a “local area network” or “LAN” is a computer communications network where the linked computers are geographically close together (e.g., in the same building). A “wide area network” or “WAN” is another computer communications network similar to a LAN except that the linked computers are farther apart (e.g., they are in different buildings and connected by telephone lines or radio waves). A “global” computer communications network is one that is not limited to a certain geographical area or number of individual computers, but rather links computers throughout the world generally without restriction. The Internet is an example of a global computer communications network.

By the phrase “electronic address” is meant a name or token that identifies a network component. For example, on the Internet, every file has a unique address called a URL or uniform resource locator which is an alphanumeric sequence that can be used to direct the browser of one computer communications network access device linked to the Internet to a Web page published by a server linked to the Internet.

When used as a verb herein, the phrases “electronic mail” or “e-mail” means to transmit one or more messages over a computer communications network. When used as a noun, these phrases mean a message transmitted over a computer communications network. The messages can be, e.g., notes entered from a keyboard or electronic files stored on disk. By the phrase “electronic post office box” or “electronic mailbox” is meant an area in memory or on a storage device where e-mail is placed. An “electronic mailbox address” or “e-mail address” is a name that identifies an electronic post office box on a network where e-mail can be sent. For example, on the Internet, all e-mail addresses presently have the form: <name>@<domain name>.

As used herein, the term “server” means a computer or device on a network that manages network resources, e.g., processes data coming in from a computer communications network, stores files in a database, and outputs files from a database over the computer communications network.

By the term “Web browser,” or simply “browser,” is meant a software application that enables one to access and use the facilities of a Web site, i.e., to locate and display Web pages.

“Computer program” means a writing that sets forth instructions that can direct the operation of an automatic system capable of storing, processing, retrieving, or transferring information. When a computer program is entered into a computer system, it forms part of the system referred to as “software.” By the term “hardware” is meant physical components of a computer system.

As used herein, a “Web site” is a site (location) on a computer communications network such as the Internet containing one or more Web pages. Most Web sites contain a “home page”, which is the main page of a Web site and usually first screen users see when they enter the site. Home pages often offer an introduction to the material contained in the Web site and also an index or table of contents hyperlinked to related Web page documents of the site. By the phrase “Web page” is meant a document published on a computer communications network.

Unless otherwise defined, all technical and legal terms used herein have the same meaning as commonly understood by one of ordinary skill in the art to which this invention belongs. Although methods and materials similar or equivalent to those described herein can be used in the practice or testing of the present invention, suitable methods and materials are described below. All patent applications mentioned herein are incorporated by reference in their entirety. In case of conflict, the present specification, including definitions, will control. In addition, the materials, methods, and examples are illustrative only and not intended to be limiting. Other features and advantages of the invention will be apparent from the following detailed description, and from the claims.

### BRIEF DESCRIPTION OF THE DRAWINGS

FIG. 1 is a block diagram of the present invention.

FIG. 2 is a screen shot of an aspect of the present invention.

FIG. 3 is a screen shot of an aspect of the present invention.

FIG. 4 is a screen shot of an aspect of the present invention.

FIG. 5 is a screen shot of an aspect of the present invention.

FIG. 6 is a screen shot of an aspect of the present invention.

FIG. 7 is a screen shot of an aspect of the present invention.

FIG. 8 is a screen shot of an aspect of the present invention.

FIG. 9 is a screen shot of an aspect of the present invention.

FIG. 10 is a screen shot of an aspect of the present invention.

FIG. 11 is a screen shot of an aspect of the present invention.

FIG. 12 is a screen shot of an aspect of the present invention.

FIG. 13 is a screen shot of an aspect of the present invention.

FIG. 14 is a screen shot of an aspect of the present invention.

FIG. 15 is a screen shot of an aspect of the present invention.

FIG. 16 is a screen shot of an aspect of the present invention.

FIG. 17 is a screen shot of an aspect of the present invention.

FIG. 18 is a screen shot of an aspect of the present invention.

FIG. 19 is a screen shot of an aspect of the present invention.

FIG. 20 is a screen shot of an aspect of the present invention.

FIG. 21 is a screen shot of an aspect of the present invention.

FIG. 22 is a screen shot of an aspect of the present invention.

FIG. 23 is a screen shot of an aspect of the present invention.

FIG. 24 is a screen shot of an aspect of the present invention.

FIG. 25 is a screen shot of an aspect of the present invention.

FIG. 26 is a screen shot of an aspect of the present invention.

FIG. 27 is a screen shot of an aspect of the present invention.

FIG. 28 is a screen shot of an aspect of the present invention.

FIG. 29 is a screen shot of an aspect of the present invention.

FIG. 30 is a screen shot of an aspect of the present invention.

FIG. 31 is a screen shot of an aspect of the present invention.

FIG. 32 is a screen shot of an aspect of the present invention.

FIG. 33 is a screen shot of an aspect of the present invention.

FIG. 34 is a screen shot of an aspect of the present invention.

FIG. 35 is a screen shot of an aspect of the present invention.

### DETAILED DESCRIPTION

The invention encompasses systems and methods relating to a litigation management program that allows attorneys, law firms, insurance companies, system administrators, and others to work together over a computer communications network to effectively and efficiently manage a large number of litigations. The below described exemplary embodiments illustrate adaptations of these systems and methods. Nonetheless, from the description of these embodiments, other aspects of the invention can be made and/or practiced based on the description provided below.

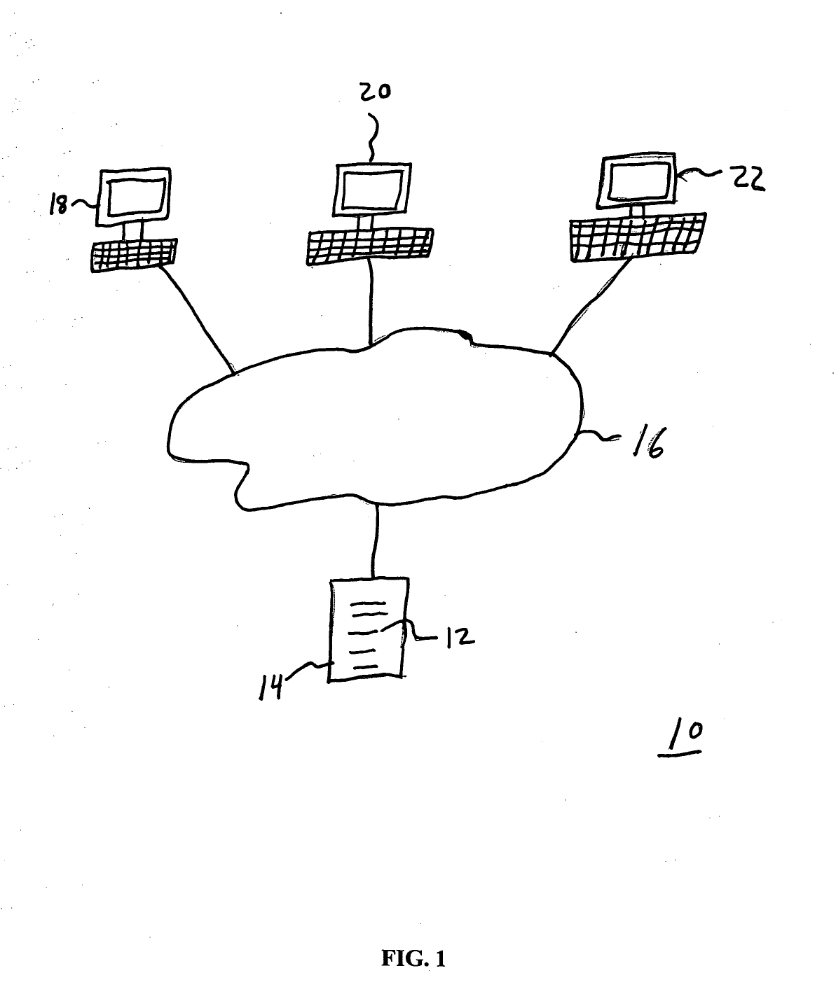

In brief overview, referring to FIG. 1, a litigation management system 10 of the invention utilizes a litigation management computer program 12 running on a server 14 connected to a computer communications network 16 (e.g., the Internet, a LAN, or a WAN). The program 12 running on the server 14 can be accessed by users (e.g., an attorney, a law firm administrator, a paralegal, an insurance company claims handler, an insurance company regional manager, a system administrator, or an expert witness) via computer communications network access devices (e.g., law firm computer 18, insurance company computer 20, and system administrator computer 22) in communication with the network 16.

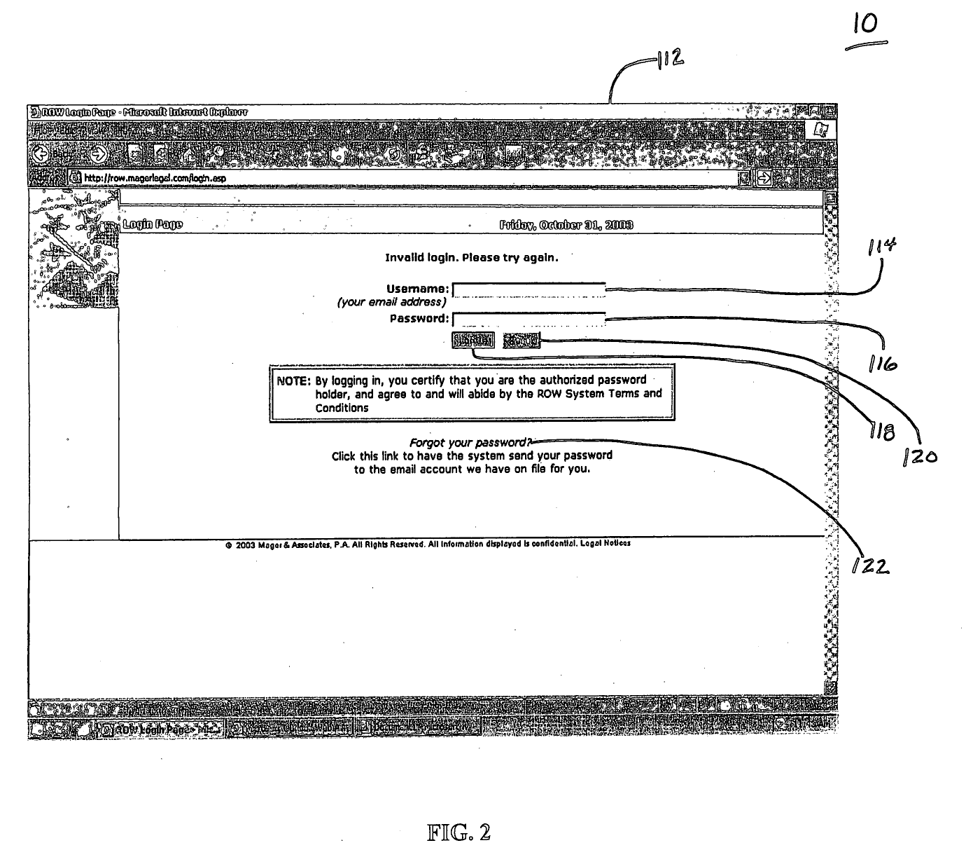

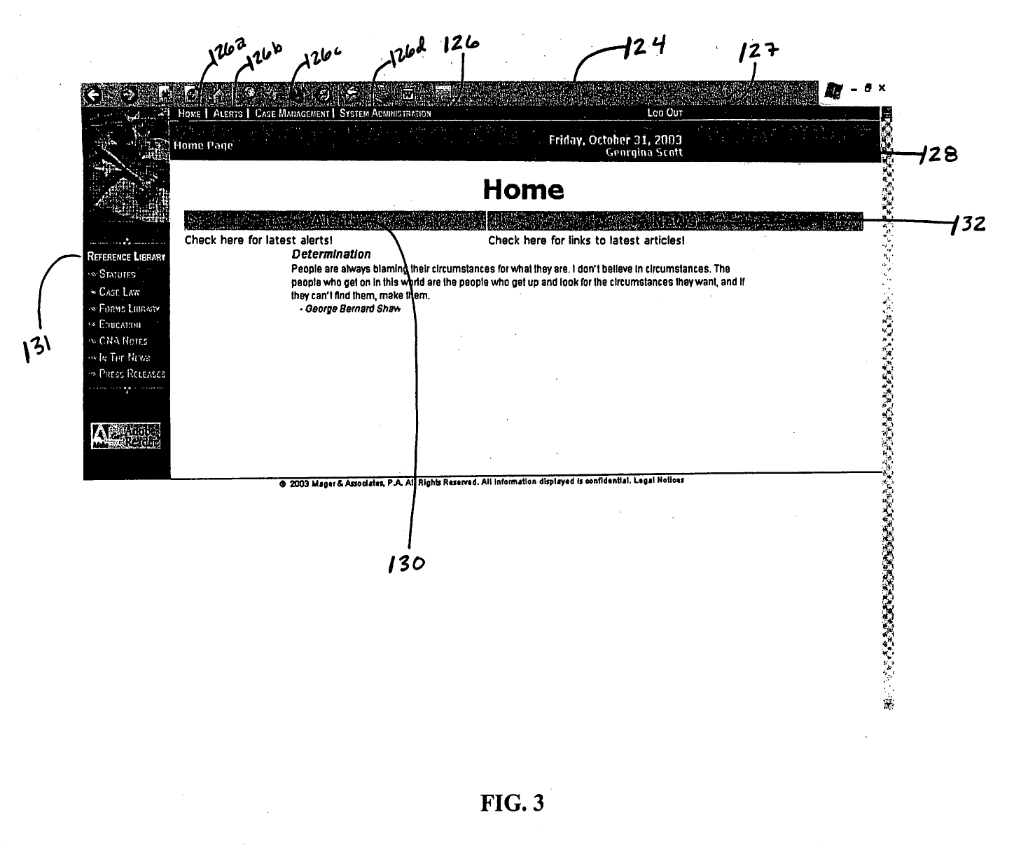

Referring now to FIG. 2, a litigation management system 110 is configured as a computer program operating on a server connected to the Internet or similar communications network. To access the system 110, a user directs a browser to a system login page 112, enters a login name (e.g., an e-mail address) in a name field 114 and a password (e.g., a four digit alphanumeric code) in a password field 116, and then clicks on a login button 118. The login page can also have other features such as a reset button 120 to clear the name field 114 and the password field 116, a password forwarding function 122 and other features such as a click-to-accept license agreement. If the login name and password are valid, the user is directed to a home page 124 as shown in FIG. 3. The system 110 can also feature a logout function so that a user can securely log off of the system 110.

Depending on the user type (e.g., attorney, claims handler, system administrator), the home page 124 can be arranged differently to accommodate the specific needs of a given type of user. In the embodiment shown in FIG. 3, the home page 124 features a navigation function 126, a log out function 127, a user identifier 128, an alerts listing function 130, a reference library function 131, and a news listing function 132. The navigation function 126 includes a home function 126a, an alerts function 126b, a case management function 126c, and a system administration function 126d.

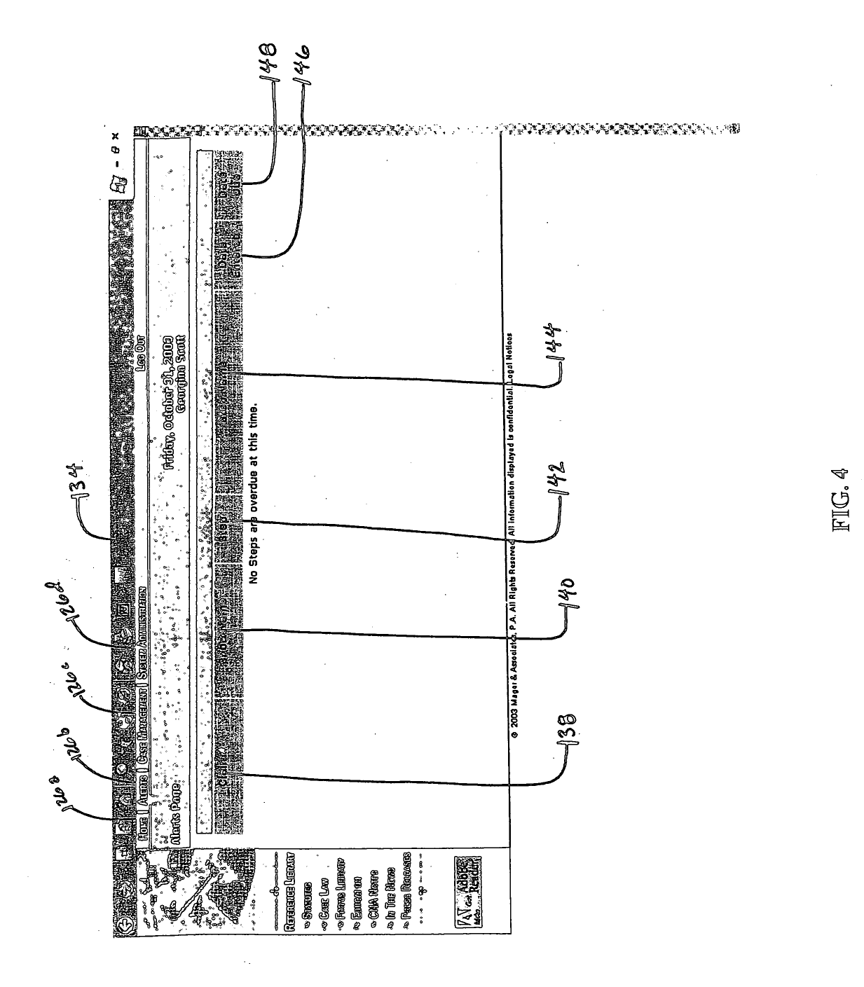

By clicking on a button associated with alerts listing function 130, the computer program directs a user to an alerts page 134 as shown in FIG. 4. Any cases associated with the user that have steps that must be completed in the near future or that are past the deadline are displayed so that the user is made aware that these cases require urgent attention. As shown in FIG. 4, the cases may be listed and/or sorted by any number of criteria, e.g., claim listing 138, name listing 140, step listing 142, step name listing 144, date entered listing 146, and date due listing 148. Each case listing may be marked with an urgency identifier such as a color. For example, case listing for cases with overdue steps might be indicated in red, while those with imminently approaching deadlines can be indicated in amber, and those that have neither overdue or imminently due steps are shown in black or green.

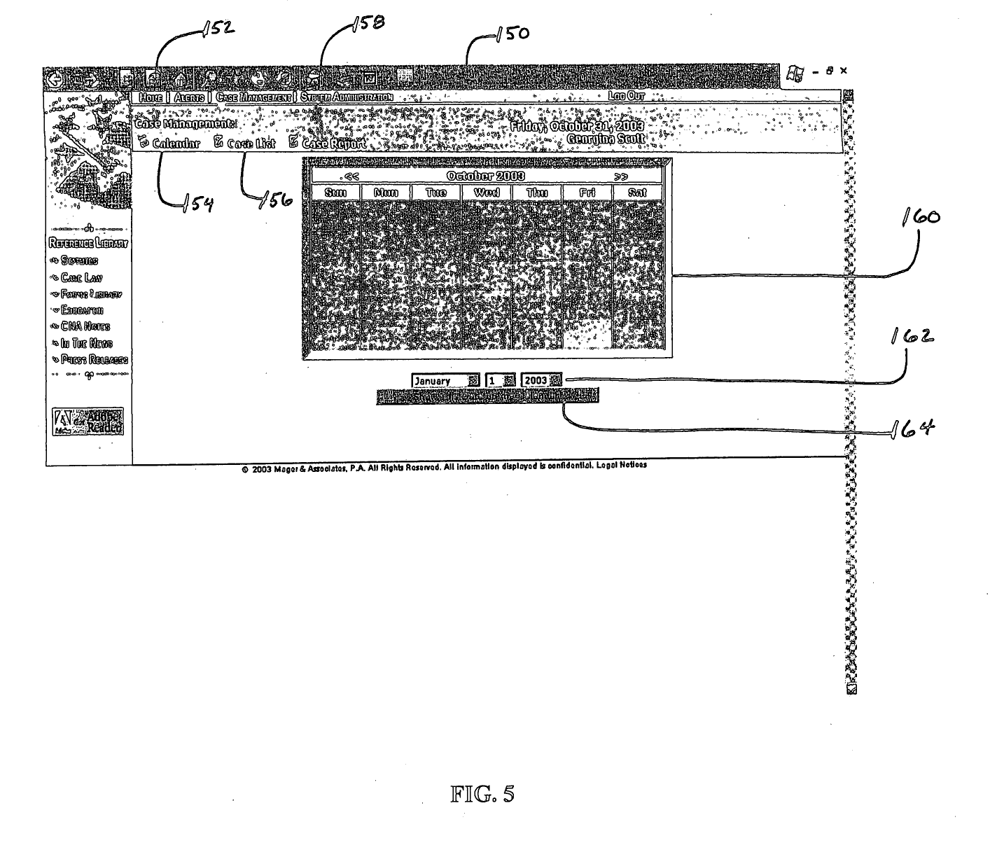

By clicking on a button associated with case management function 126c, a user is directed to a case management page 150 as shown in FIG. 5. Case management page 150 includes a case management navigation function 152, a calendar function 154, a case list function 156, and a case report function 158. In the page shown in FIG. 5, a calendar 160, date entry field 162, and new date function 164 are accessed by a user clicking on the button associated with the calendar function 154 on the case management page 150. The calendar 160 shows any alerts or due dates for cases associated with the user. The calendar might be configured to show one month at a time (as in FIG. 5), one day at a time, one week at a time, one year at a time, or any other time period. The date entry field 162 and new date function 164 allow a user to input a particular date to be shown in calendar 160.

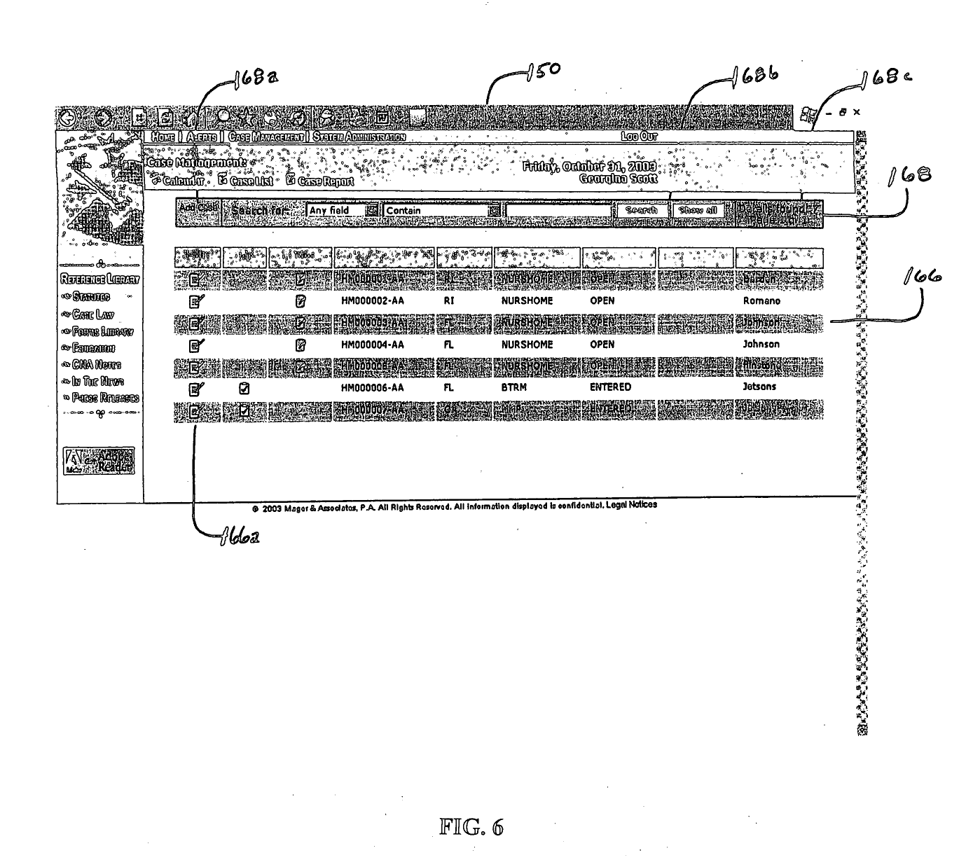

In the page shown in FIG. 6, a case list 166, a case list edit function 166a, a case detail function 168, a case add function 168a, a case search function 168b, and a case details function 168c are accessed by a user clicking on the button associated with the case list function 156 on the case management page 150. The case list 166 displays various information about cases associated with a user, e.g., the claim number, the jurisdiction or state where the case was brought or is pending, the type of case (e.g., nursing home liability, medical malpractice, birth trauma, etc.), the status of the case (e.g., open, closed, stayed, settled, assigned, initialized, etc.), the category of the case, the name of the case, the defendant's name, the plaintiff's name, the law firm handling the case, the name of the responsible attorney, the name of the insurance company claims representative, etc.

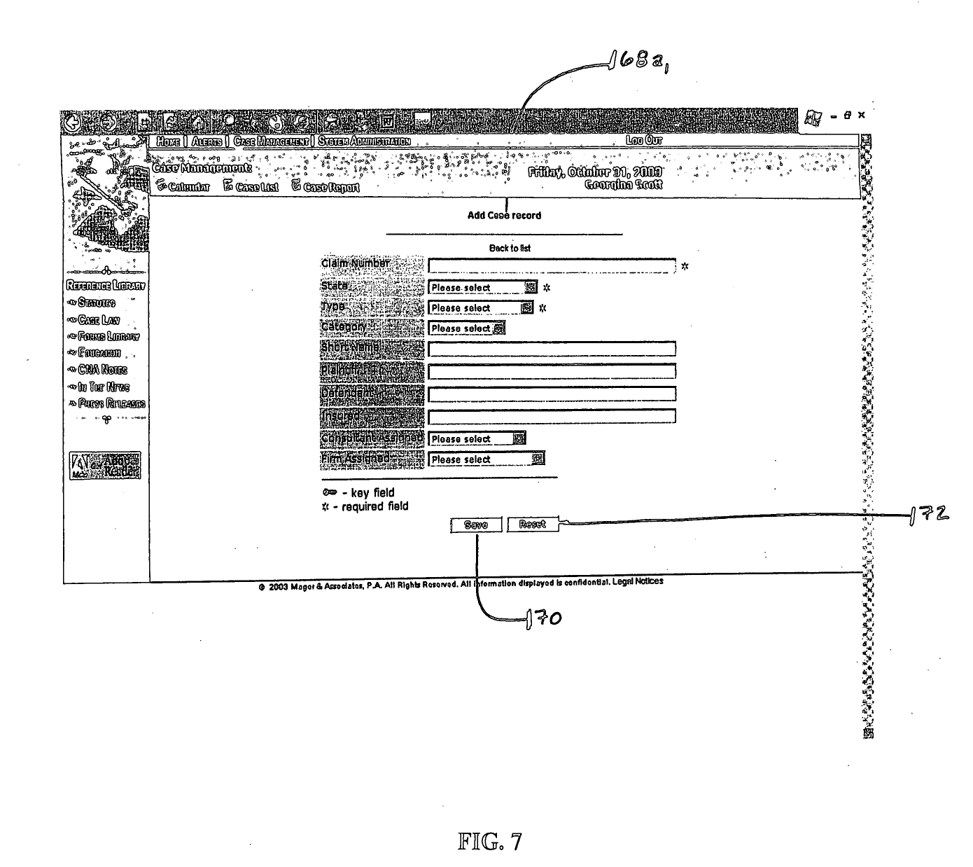

Referring to FIG. 7, an add case record page 168a1 is accessed by a user clicking on the button associated with the add case function 168a within the case detail function 168 on the case management page 150. Case record page 168a1 has several fields that can be used to enter data about a new case to be added to system 110. After a user enters the information into the fields, the user can click on a button associated with a save case record function 170 to add the new case to the system 110. If incorrect information is entered into the fields, a user can clear all the fields by clicking on a button associated with reset case record function 172.

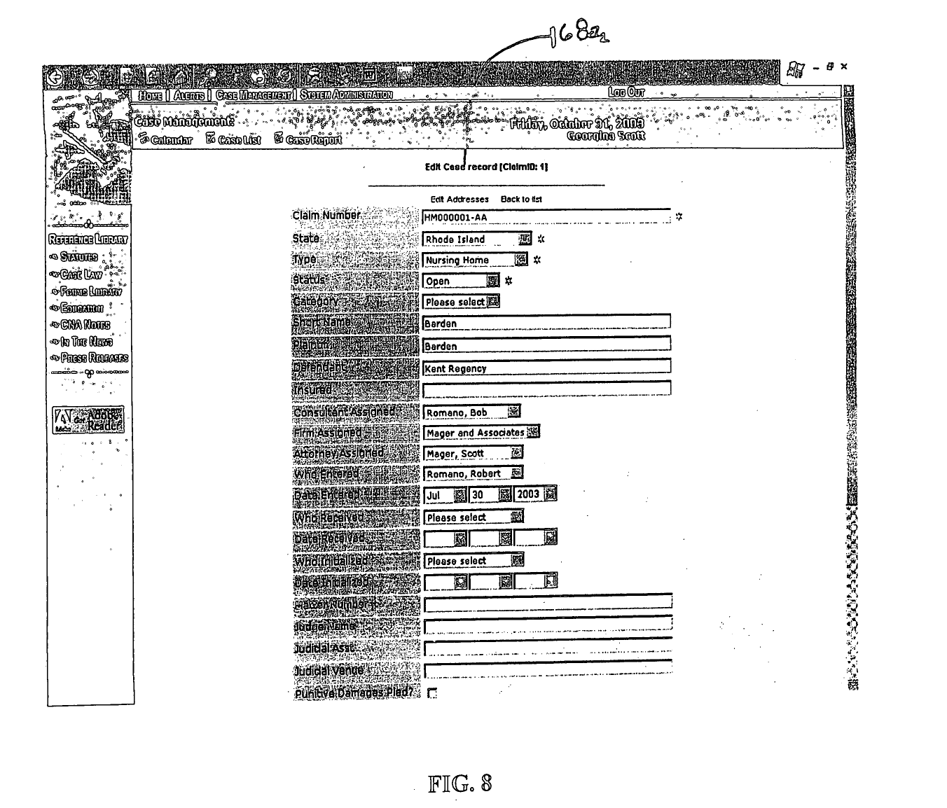

An edit case record page 168a2 is accessed by a user clicking on the button associated with the edit case function 166a within the case list 166 displayed on the case management page 150 as shown in FIG. 8. Edit case record page 168a2 has several fields that can be used to enter new data or modify existing data associated with a case previously entered into system 110. After a user enters the information into the fields, the user can click on a button associated with the edit case function 166a to modify the information about the case in the system 110. If incorrect information is entered into the fields, a user can clear all the fields by clicking on a reset button.

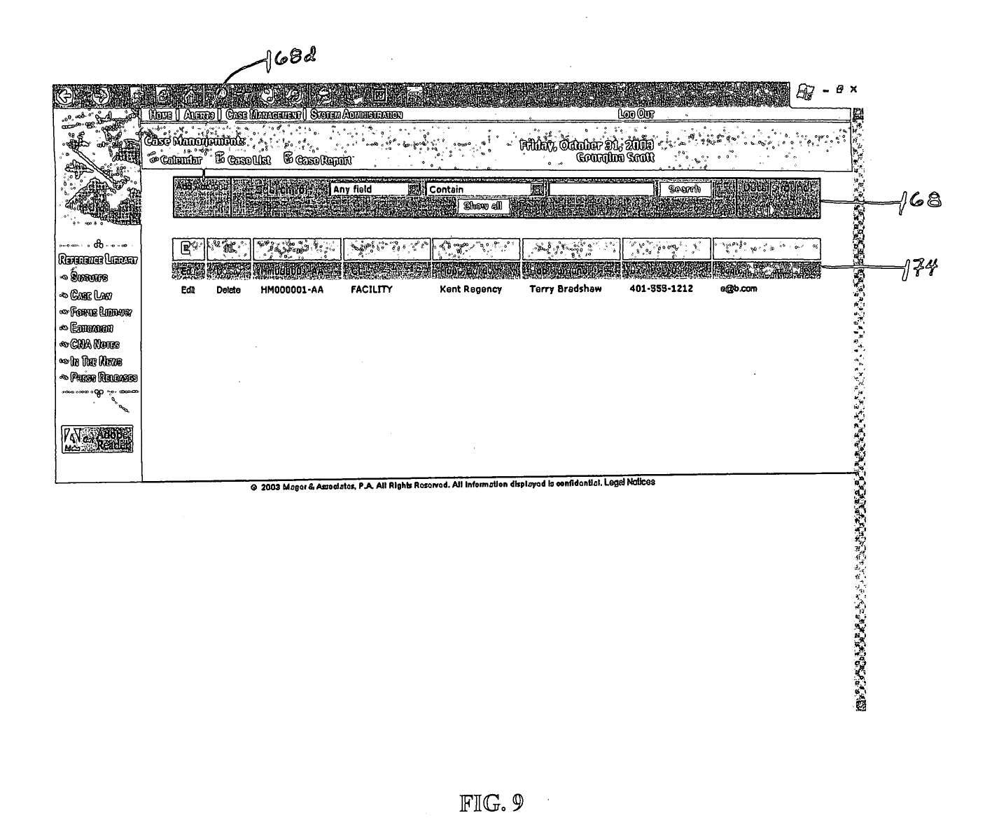

By clicking on a button associated with the case details function 168c on the case management page 150, a user can access a page displaying case detail 174 as shown in FIG. 9. The case details 174 can include a variety of different information about a case, e.g., the case number, the address type (e.g., client or hospital), the client name, the name of the client contact person, and the client's contact information. This page can also feature a means for adding new details about a case 168d and for searching the system 110 for cases matching user selected criteria.

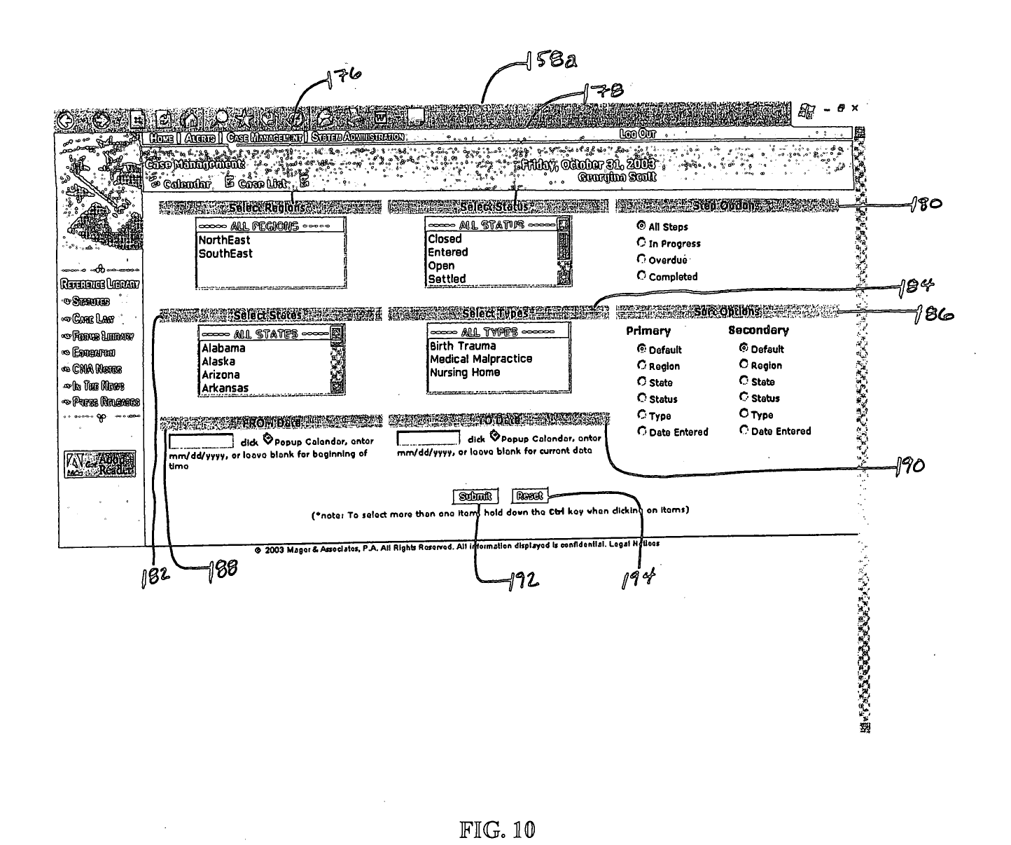

Referring now to FIG. 10, the case report page 158a is accessed by a user clicking on the button associated with the case report function 158 on the case management page 150. Case report page 158a has a region selection function 176, a status selection function 178, a step selection function 180, a state selection function 182, a case type function 184, a sort selection function 186, a beginning date function 188, an ending date function 190, a submit function 192, and a reset function 194. A user of the system 110, selects or enters various criteria via one or more of the various functions on page 158a, and then selects the submit function 192 to generate a list of cases matching the entered criteria. The user thus has the ability to generate custom case reports based on desired criteria. For example, a user could generate a list of cases that have overdue steps.

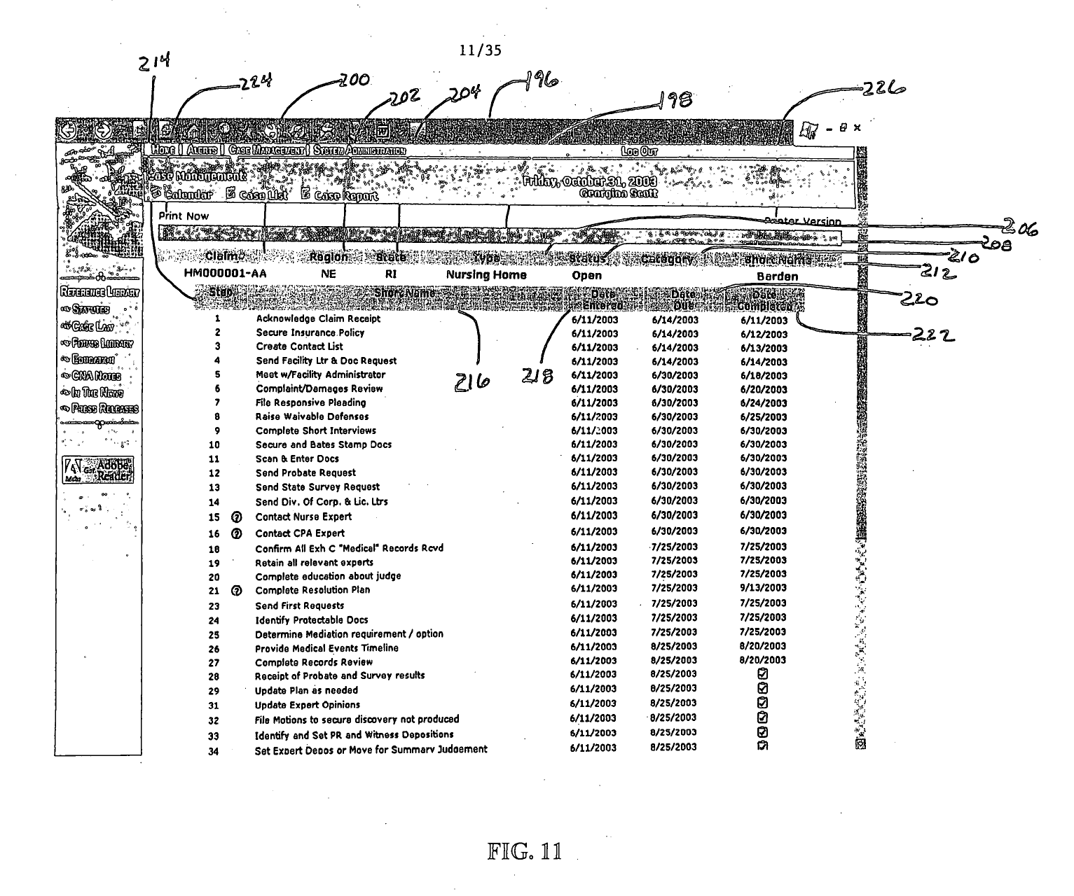

By clicking on a button associated with the case report function 158 on the case management page 150, a user can access a case report page 196 as shown in FIG. 11. The case report page 196 displays a case report 198 which includes detailed information about a single case in system 110. The information can include case identifying information such as a claim number 200, the region 202 and state 204 where the case is situated, the case type 206, the case status 208, the case category 210, the case name (or short name) 212, and a list of steps to be completed in the case. The lists of steps to be completed can be organized by date due, and can display various information about the steps, e.g., the step identifier 214, the name 216 of the step, the entry date 218 of the step, the due date 220 of the step, and the completion date 222 of the step. The lists of steps can be color-coded or otherwise marked according to status (e.g., red for overdue, amber for soon due, black or green for neither overdue or soon due, yellow for mandatory, blue for not mandatory, and underlined for court deadlines).

An icon might be associated with a given step to provide a link to additional information, e.g., practical advice, training, and information; checklists of questions to ask a party; sample forms/letters; and links to mapping programs to show location/driving instructions to a site. For example, for a step of filing a motion to dismiss might have a link to jurisdiction-specific forms and memorandums of law in support of the motion, statutes, case law, and education/training content relating to a motion to dismiss (e.g., a law review article on motions to dismiss and a video clip on how to argue a motion in court). The case report page 196 can also feature a print option function 224 and a printer version function 226. Other information accessible on or through the case report page 196 includes an estimation of the case value (e.g., how much the insurance company might be liable for if the defendant loses the litigation) and an estimation of attorneys fees and costs for handling a case. This information may be particularly valuable for an insurance company deciding how to handle the case.

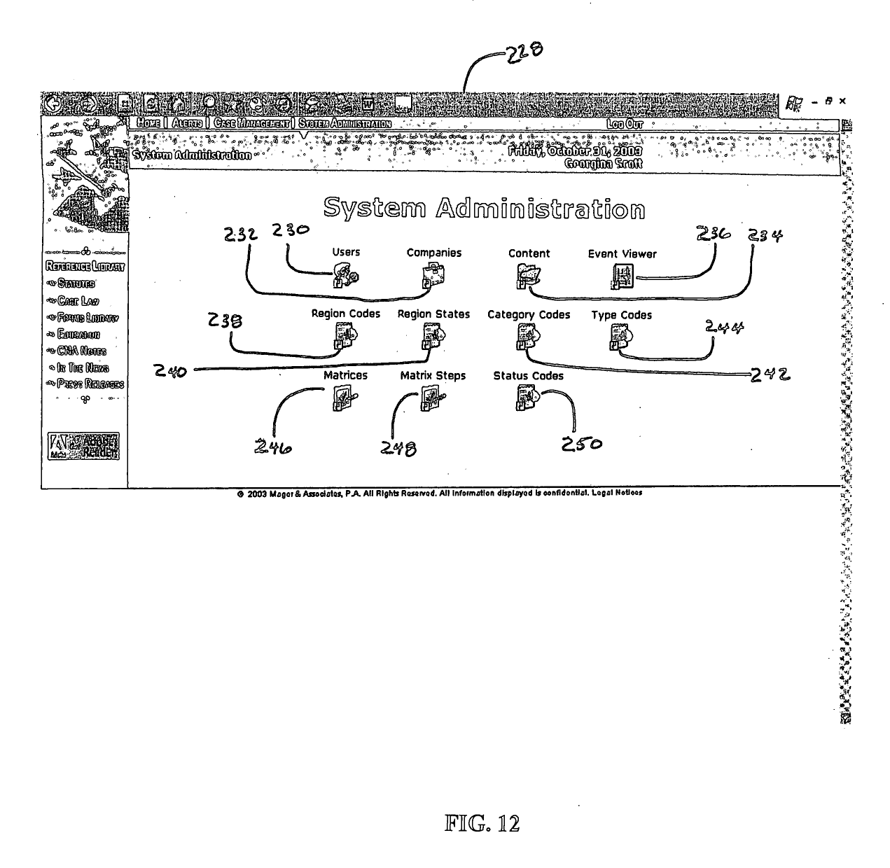

To access the system administration function page 228 shown in FIG. 12, a system administrator clicks on a button associated with system administration function 126c. System administration function page 228 allows a system administrator to update, add, and delete data from the system 110, and to do so can include a users selection function 230, a companies selection function 232, a content selection function 234, an event viewer selection function 236, a regions codes function 238, a regions state function 240, a categories codes function 242, a type codes function 244, a matrices function 246, a matrix steps function 248, and a status codes function 250. The ability of a system administrator to continually update the system reduces attorney time spent finding such updates manually.

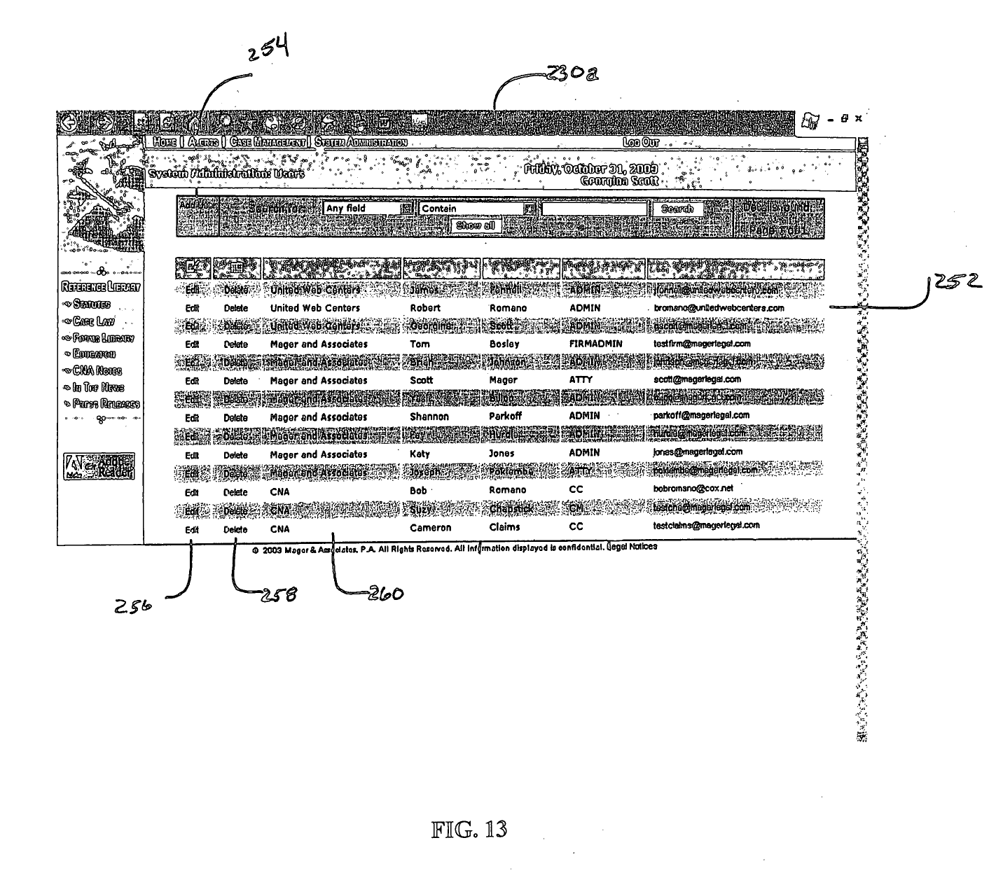

Referring to FIG. 13, a system administrator can access a users selection page 230a by clicking on a button associated with the users selection function 230. The users selection page 230a includes a user listing 252, an add user function 254, an edit user function 256, and a delete user function 258. The user listing 252 is a list of users of the system 110 that can be organized by company, first name, last name, user type (e.g., administrator, attorney, claims consultant, claims manager, etc.) and user contact information. The user listing 252 can be updated by an authorized system administrator using the add user function 254, edit user function 256, and/or delete user function 258.

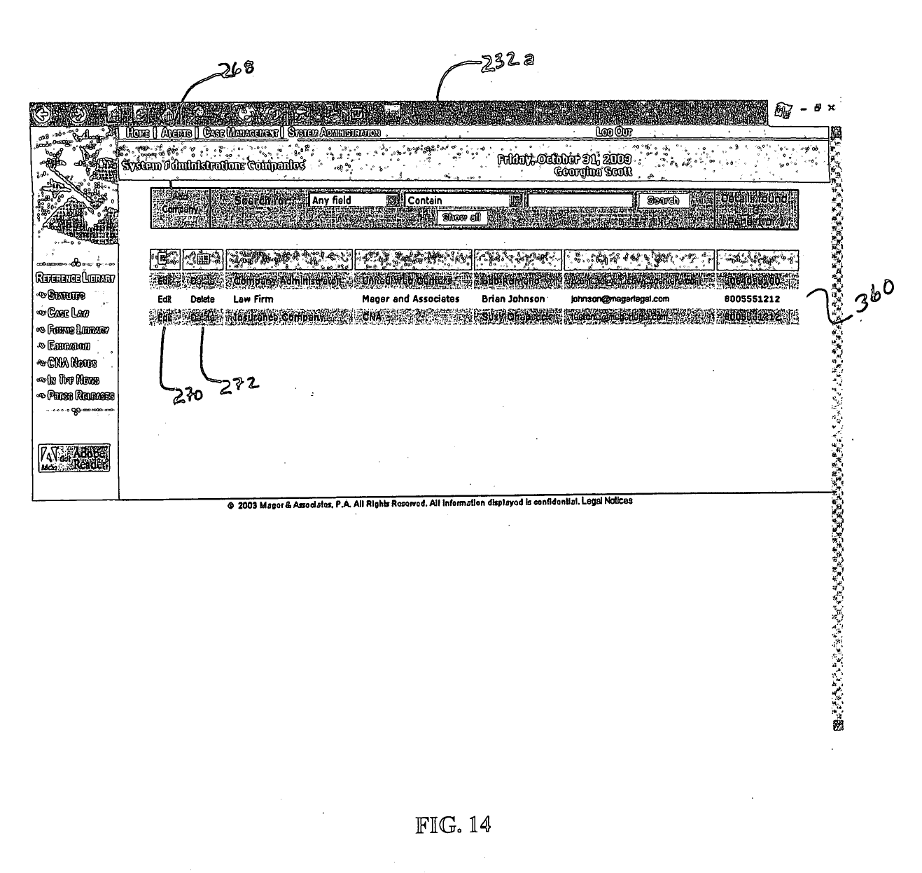

Referring to FIG. 14, a system administrator can access a companies page 232a by clicking on a button associated with the companies selection function 232. The companies page 232a includes a companies listing 360, an add company function 268, an edit company function 270, and a delete company function 272. The companies listing 360 is a list of companies using the system 110 that can be organized by company type (e.g., law firm, system administrator, and insurance company), company name, company contact name, and user company contact information. The companies listing 360 can be updated by an authorized system administrator using the add company function 268, edit company function 270, and a delete company function 272.

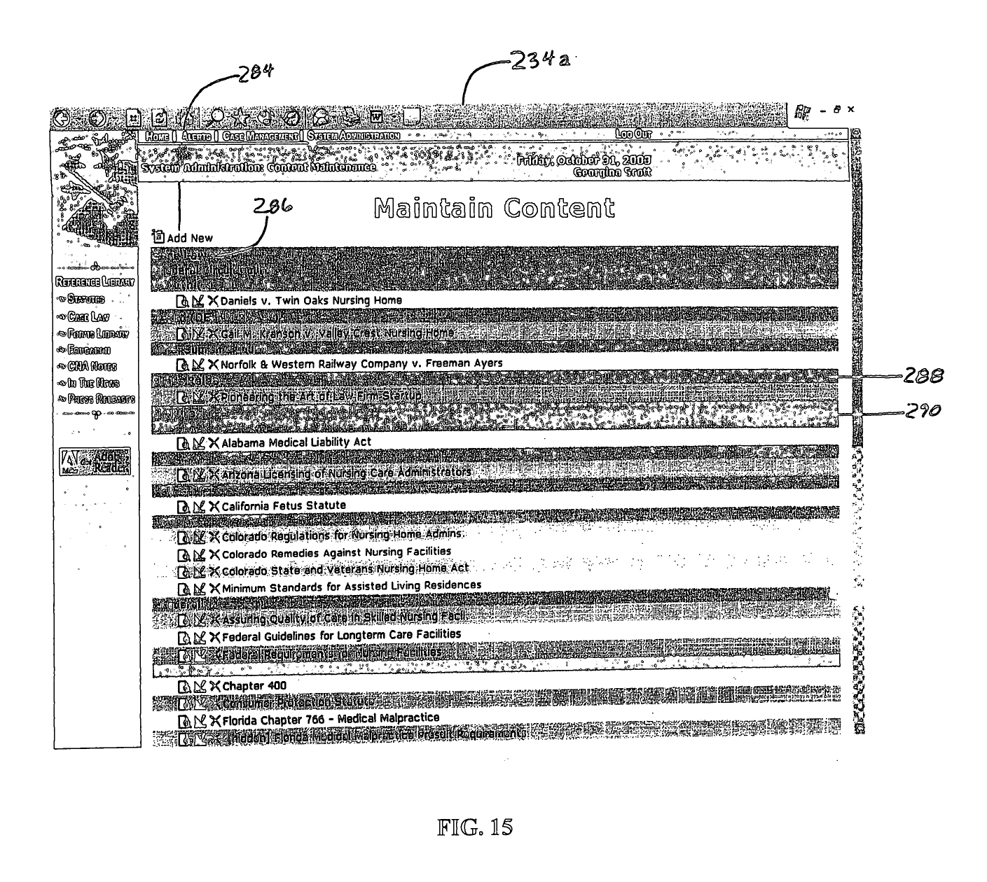

A system administrator can also control the information content of system 110 by accessing the content maintenance page 234a (See e.g., FIG. 15) by clicking on a button associated with the content maintenance function 234. The content maintenance page 234a features a means to add 284, delete, or modify the contents on the system 110. Examples of content on the system 110 include statutes 290 (federal and state), administrative regulations and other material (federal and state), case law 286 (federal and state), press releases 288 and other news, forms, educational/training materials, and notes from insurance companies and law firms.

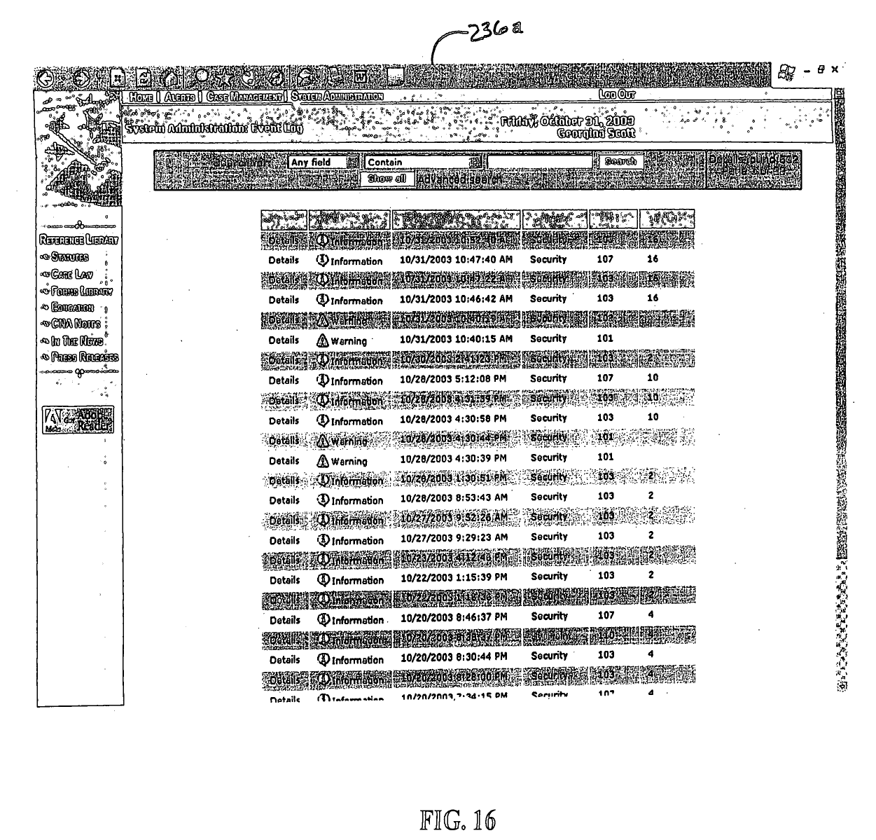

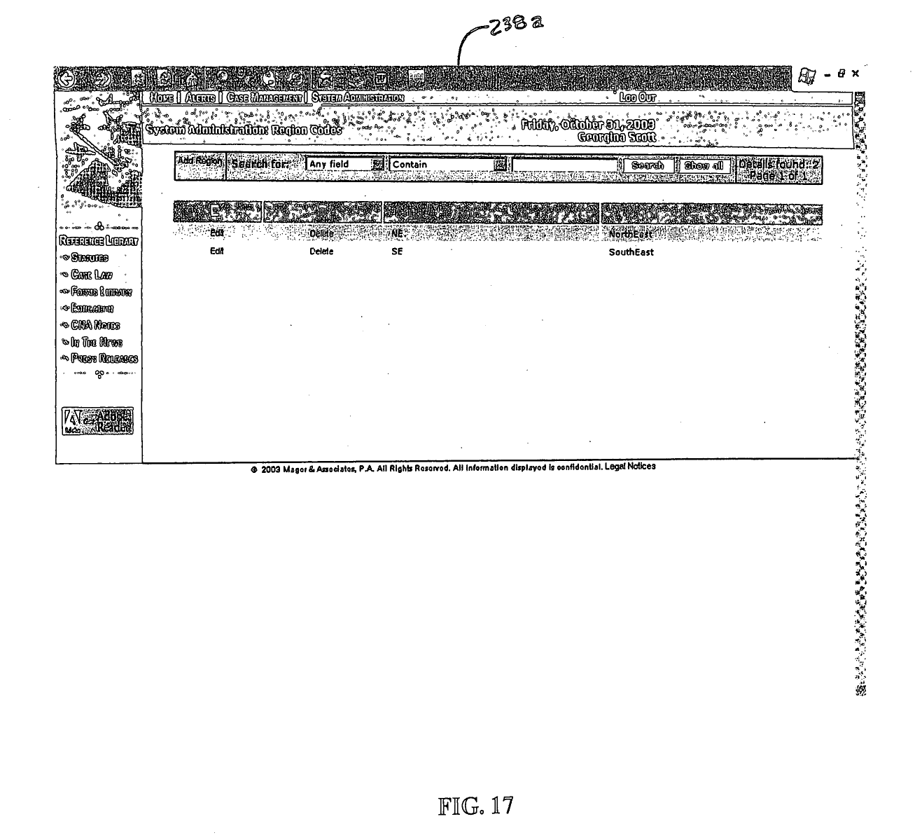

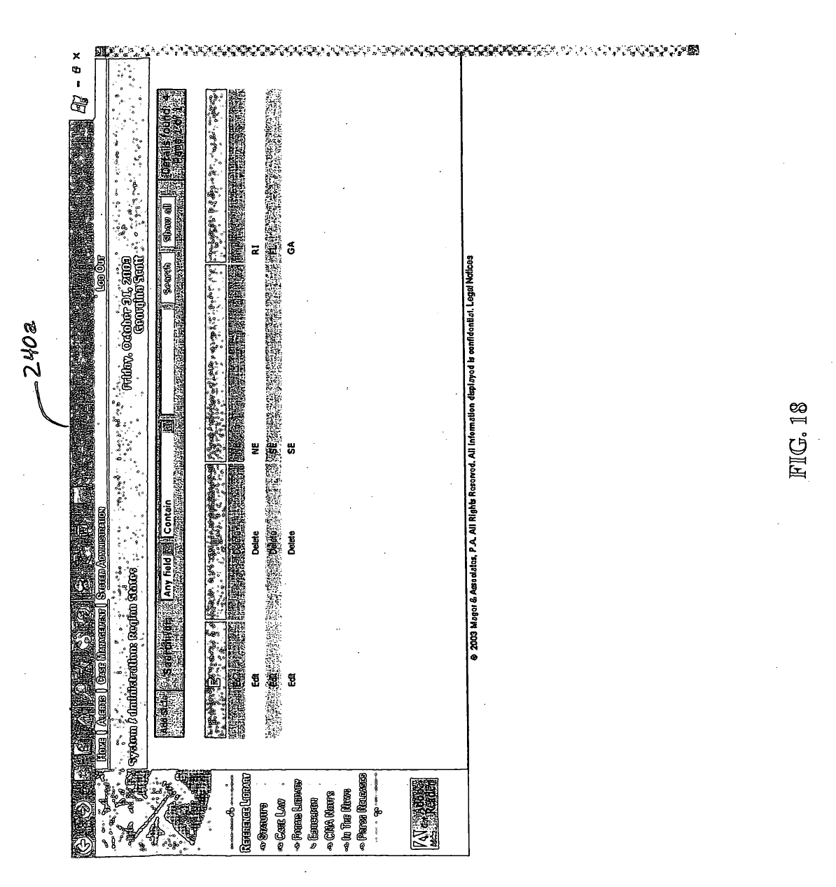

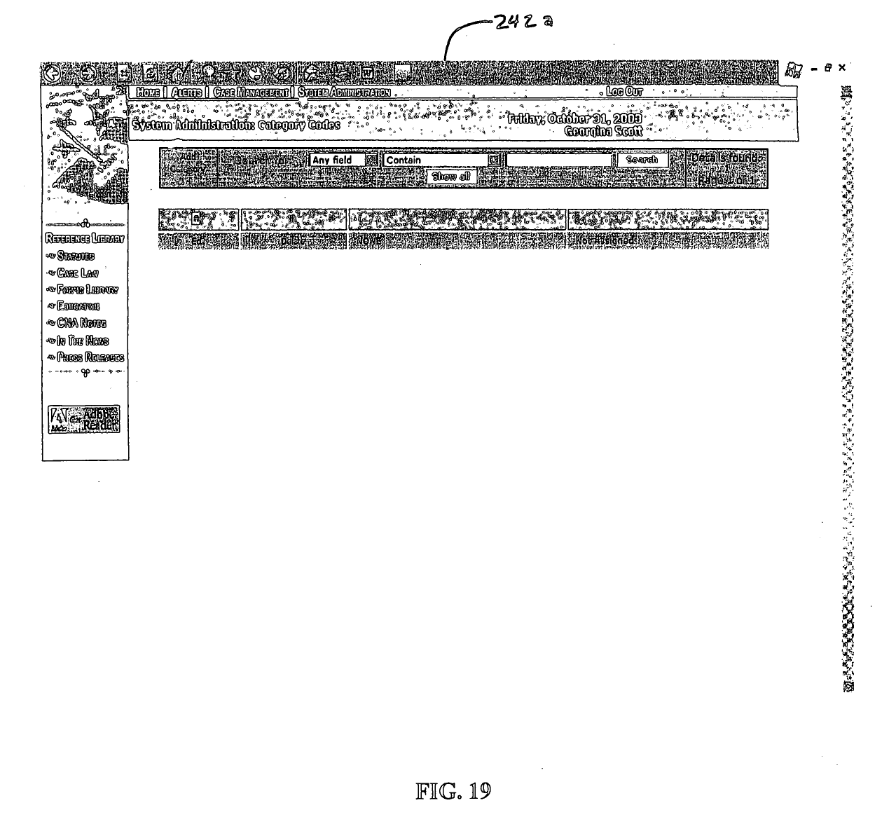

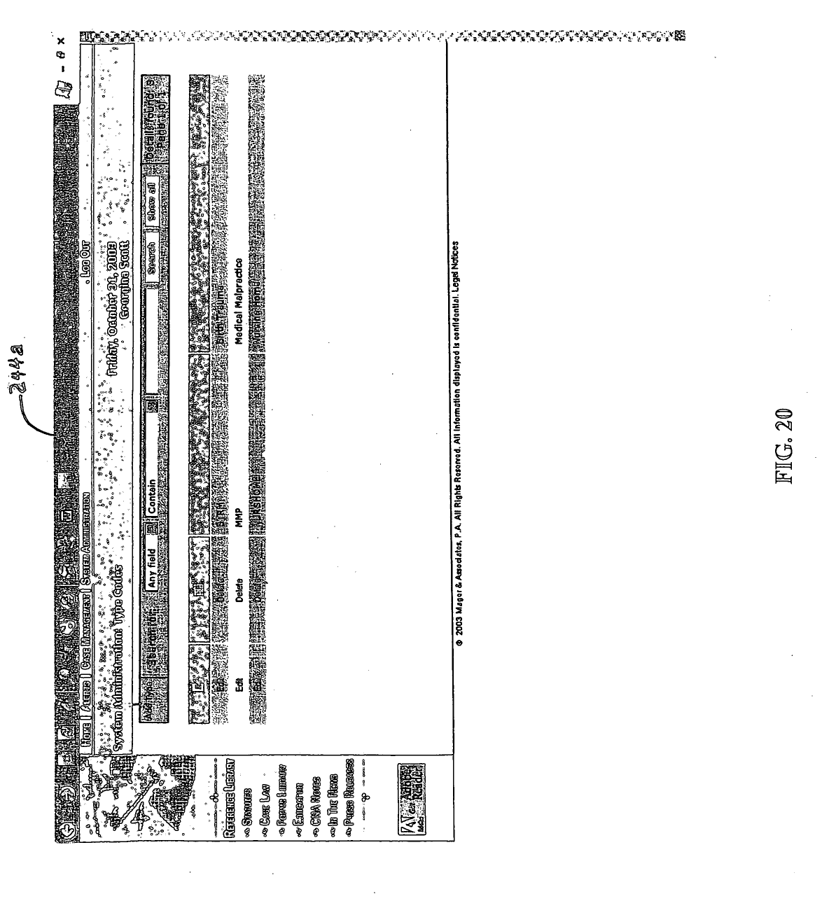

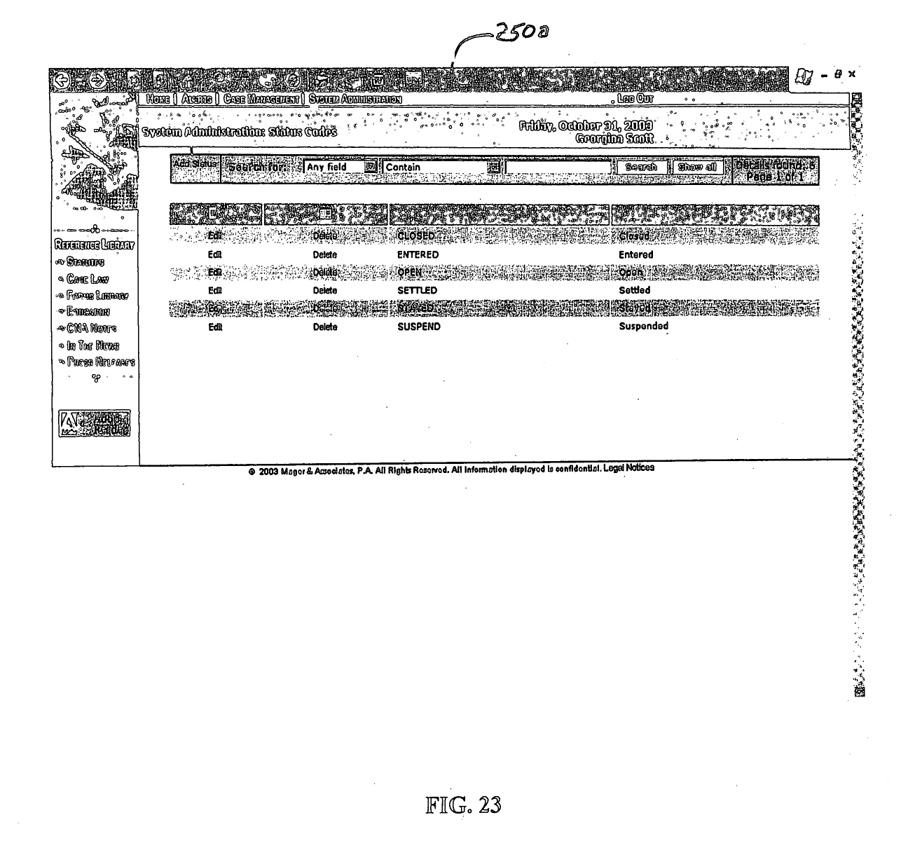

Other components of system administration function 126c include the event viewer selection function 236, the regions codes function 238, the regions state function 240, the categories codes function 242, the type codes function 244, the matrices function 246, the matrix steps function 248, and the status codes function 250. The event viewer selection function 236 allows a system administrator to monitor system events such as user logon/logoff and changes to the system 110. The events can be listed according to time/date of an event, the user, the type of event, etc. (See, e.g., event log 236a of FIG. 16) The regions codes function 238, the regions state function 240, the categories codes function 242, the type codes function 244, and the status codes function 250 provide a means through which a system administrator can add, delete, or change how data is presented in the system 110. For example, a system administrator can add or delete regions or states from the system 110 using the regions codes function 238 (See, e.g., region codes page 238a of FIG. 17) and the regions state function 240 (See, e.g., region states page 240a of FIG. 18). Similarly the regions codes function 238 and the regions state function 240 allow a system administrator to modify codes associated with a region or state (e.g., FLA to FL for the state of Florida). Similarly, the categories codes function 242 (See, e.g., category codes page 242a of FIG. 19) allows a system administrator to add, delete, or change codes for a category; the type codes function 244 (See, e.g., type codes page 244a of FIG. 20) allows a system administrator to add, delete, or change codes for a type of case (e.g., add the code MMP for medical malpractice); and the status codes function 250 (See, e.g., status codes page 250a of FIG. 23) allows a system administrator to add, delete, or change codes for a case status (e.g., add “stayed” to the selection of status codes). In this manner, a system administrator has unlimited ability to modify the system 110 according to a given set of needs.

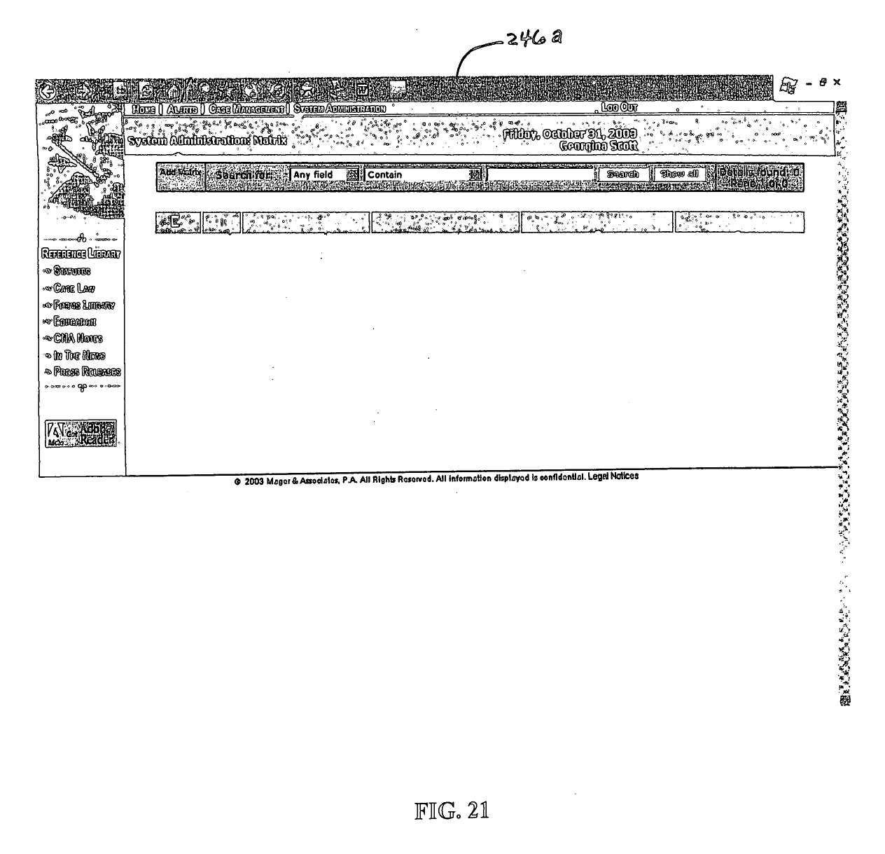

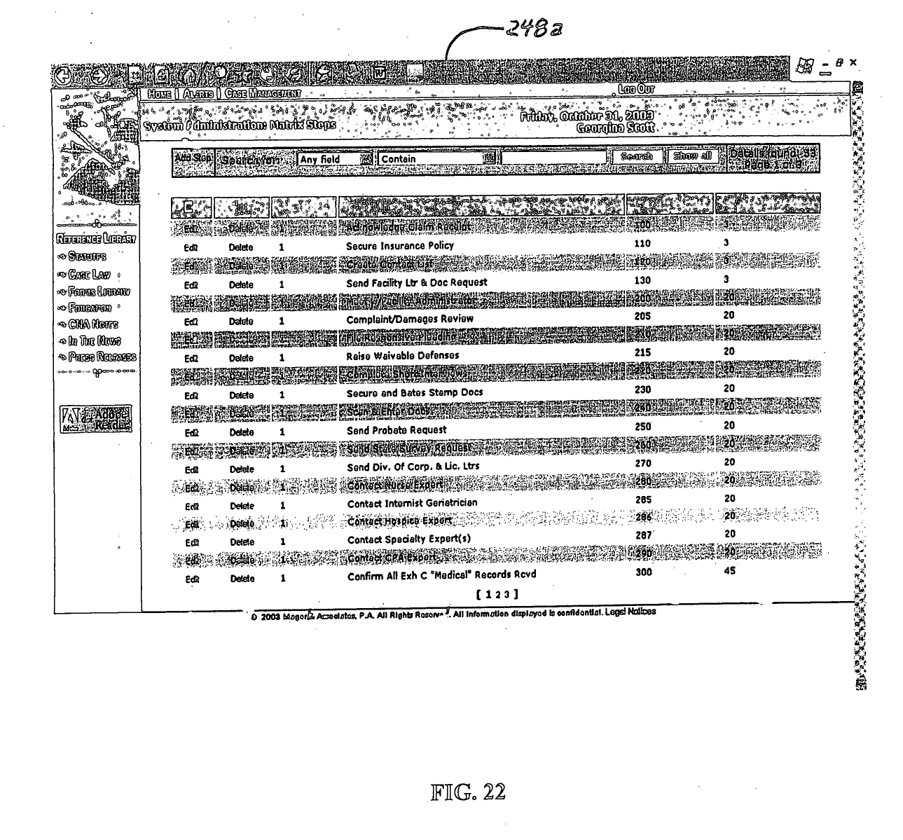

The matrices function 246 and the matrix steps function 248 allow a system administrator to add or modify matrices for handling a given type of case. For example, using the matrices function 246 (See, e.g., matrix page 246a of FIG. 21), a system administrator can add a new case type (e.g., nursing home liability) to the system 110 that includes a list of all steps an attorney needs to or might take in such a case. Once a new matrix has been created, a system administrator can modify the matrix utilizing the matrix steps function 248 (See, e.g., matrix steps page 248a of FIG. 22) which allows the administrator to add, delete, or modify individual steps within the matrix or to link additional information to a step (e.g., for the step of deposing an expert witness, the step in the list might contain a link to a taking depositions training video).

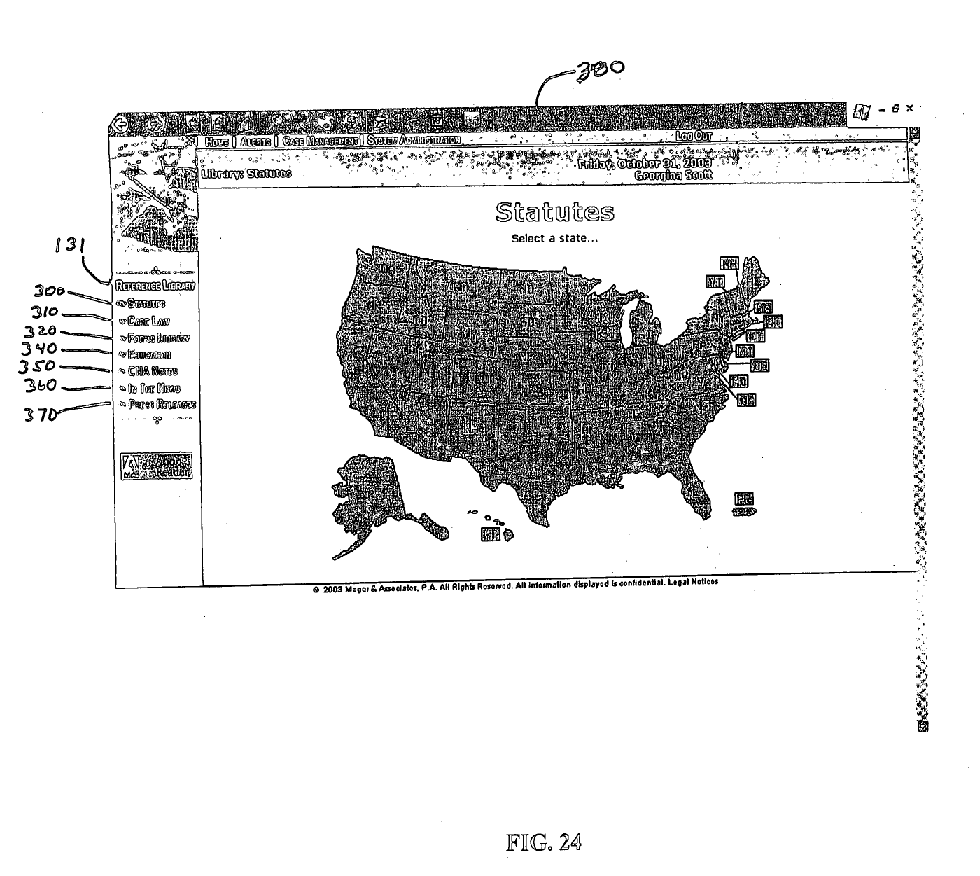

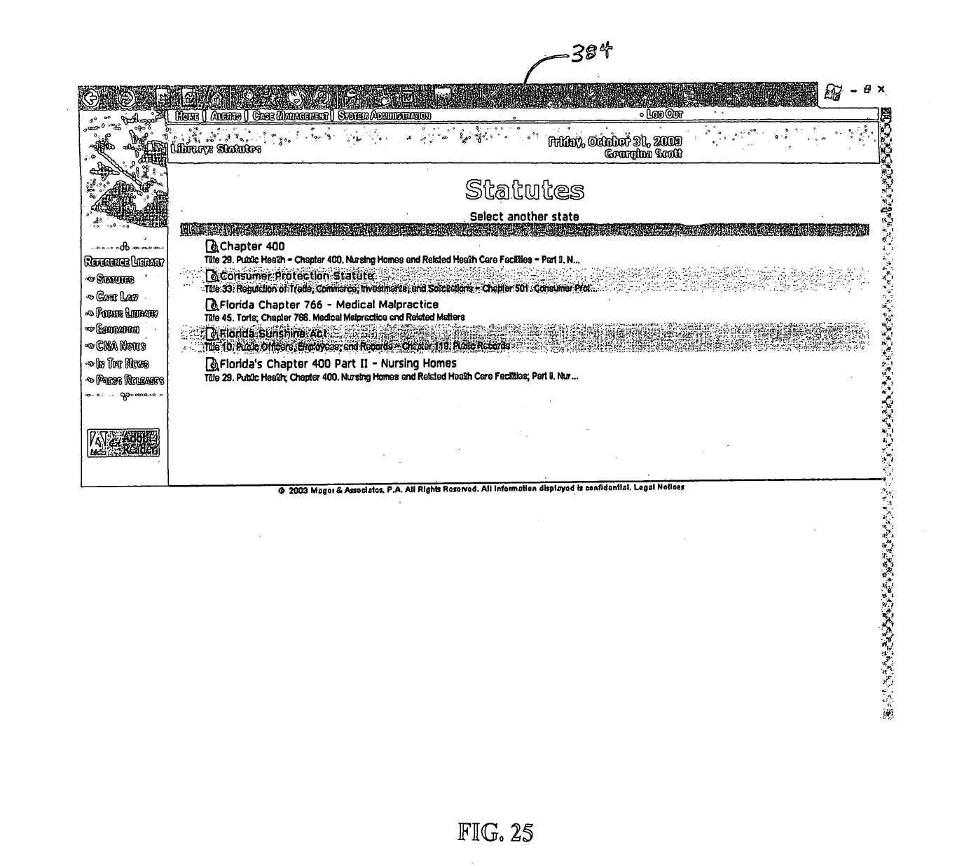

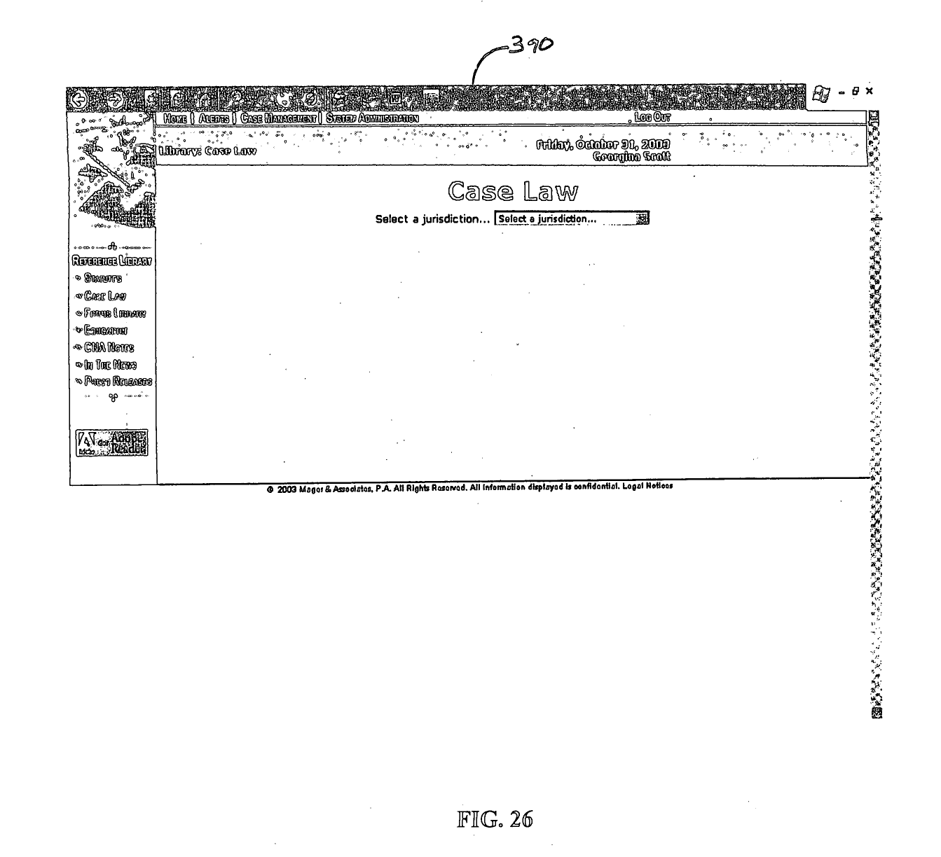

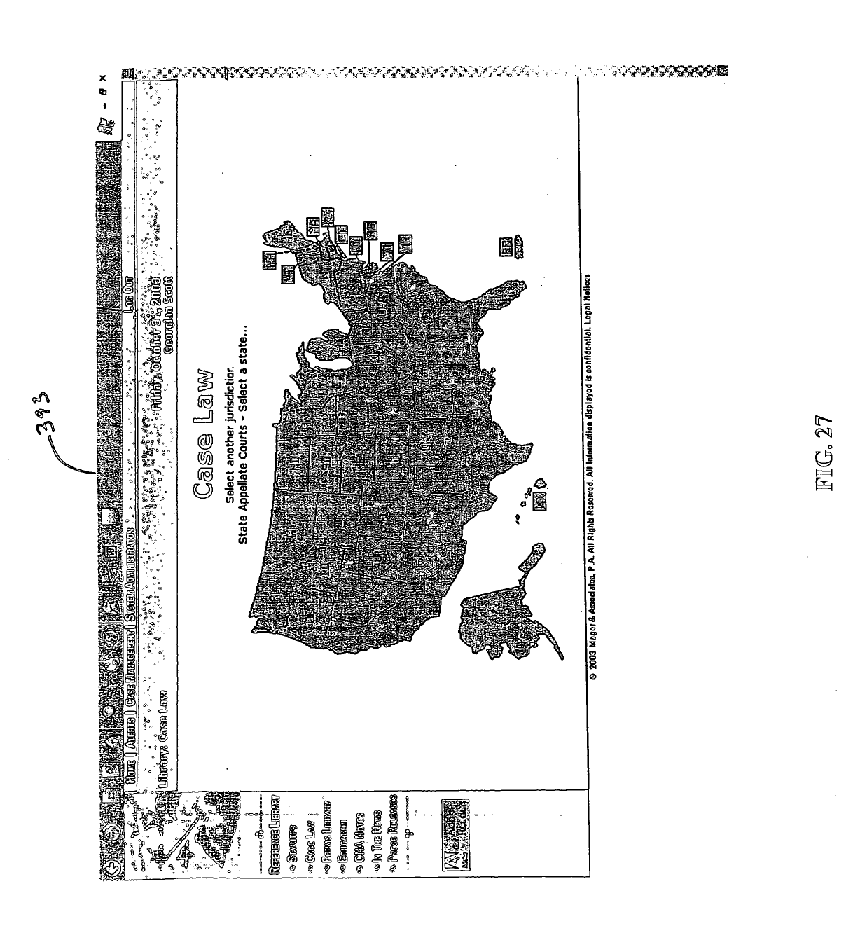

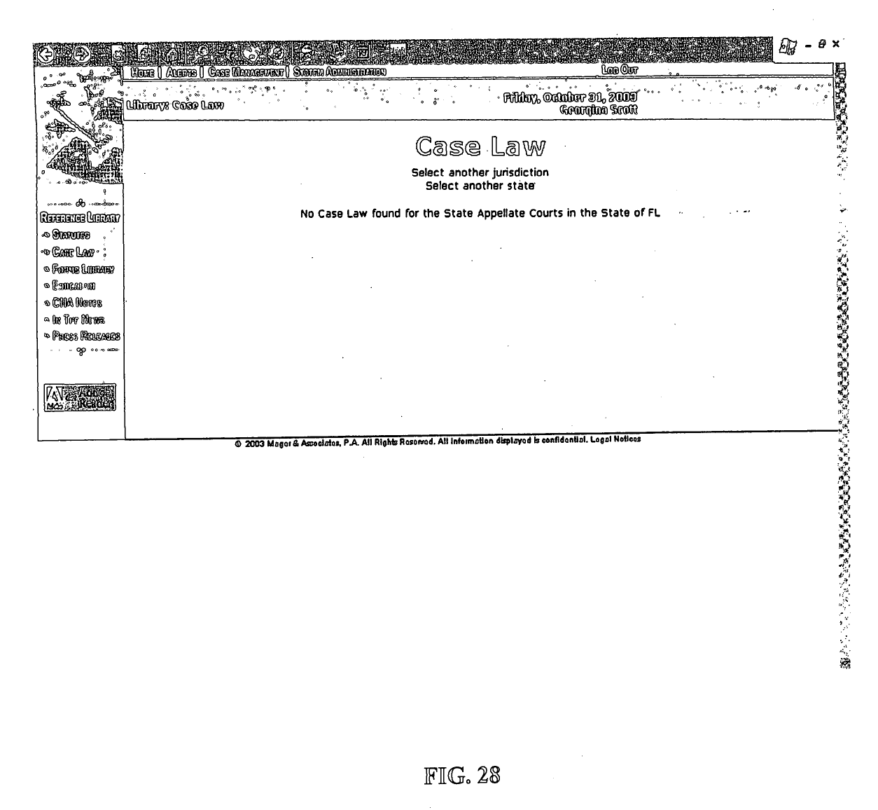

Another important feature of system 110 is the reference library function 131. Reference library function 131 provides a user access to information useful for handling a litigation case. For example, in FIG. 24, the reference library function 131 includes a statutes tab 300 (and optionally an administrative regulations tab), a case law tab 310, a forms library tab 320, an education tab 340, a notes tab 350, a news tab 360, and a press releases tab 370. A user of system 110 would click on one of the foregoing tabs to be directed to pages having the indicated information. For example, referring to FIG. 24, clicking on the statutes tab 300 directs a user to a statutes library page 380 having a map of the United States. A user selects a particular state or federal court jurisdiction to be directed to the pertinent statutes as shown, for example, on statutes page 384 in FIG. 25 (e.g., a website hosted by that government entity that lists its current statutes). In a similar manner, a user selecting the case law tab 310 is directed to a case law library page 393 having a map of the United States (See, e.g., screens 390 and 393 in FIGS. 26, 27, also see FIG. 28). A user selects a particular state or federal court jurisdiction to be directed to the pertinent case law.

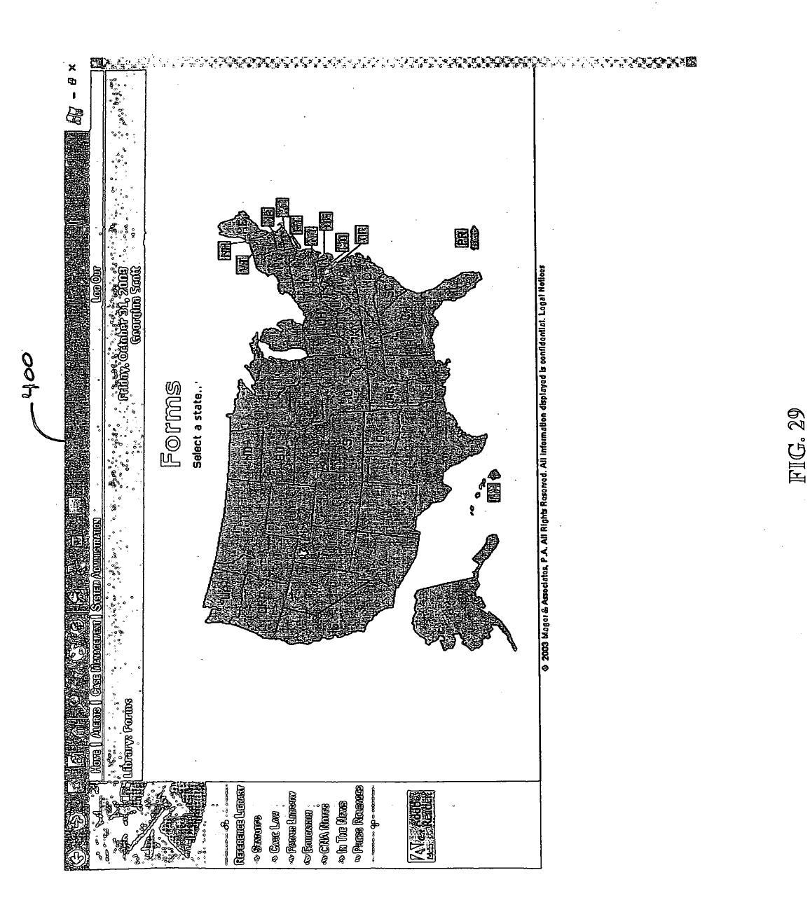

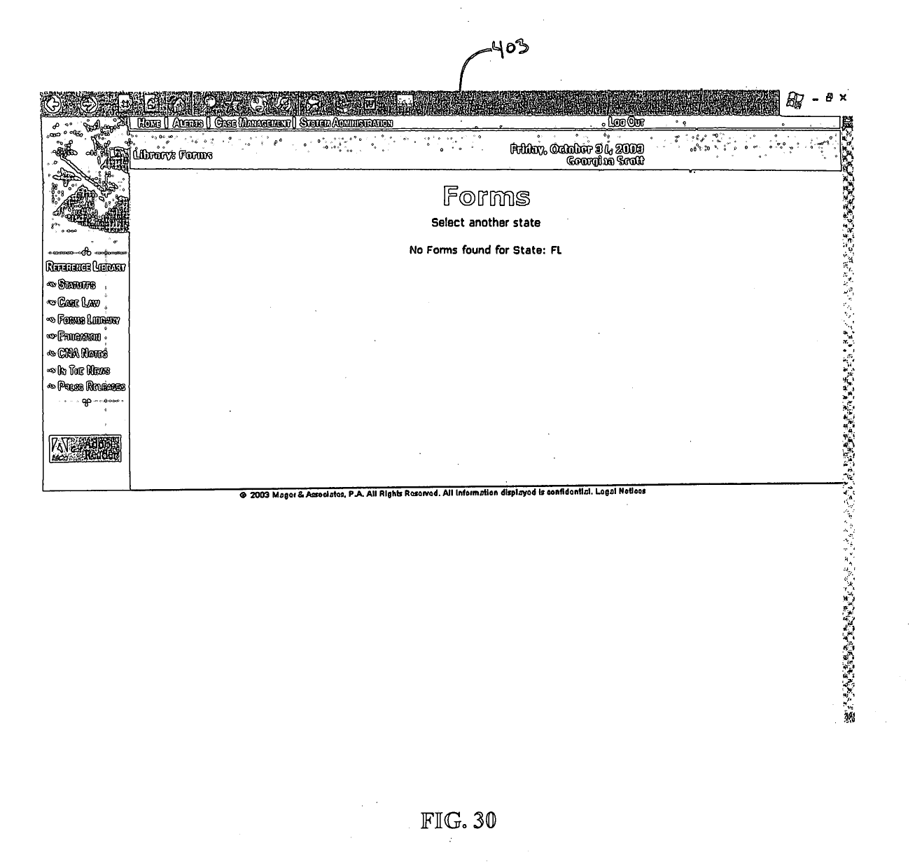

Selecting the forms library tab 320 would direct a user to a form library page that has a list of forms organized by subject matter and/or jurisdiction. Forms that might be included in the library page could be any that could be helpful in handling a litigation, e.g., letters to clients, letters to witnesses, motions, memorandum, state-specific forms, insurance company forms, etc. The full form could be viewed by clicking on the description of the form in the list on the library page. The forms may be linked to a document assembly program. Referring to FIGS. 29 and 30, clicking on the forms library tab 320 directs a user to a forms page 400 (FIG. 29) having a map of the United States. A user selects a particular state or federal court jurisdiction to be directed to the pertinent forms (See, e.g., screen 403 in FIG. 30).

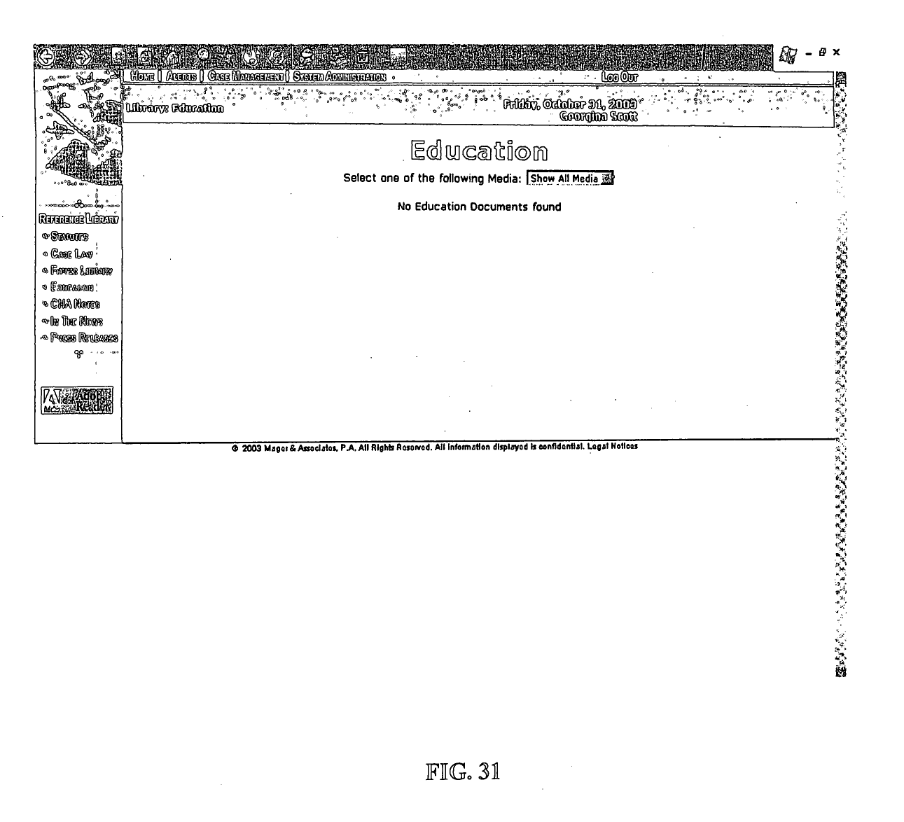

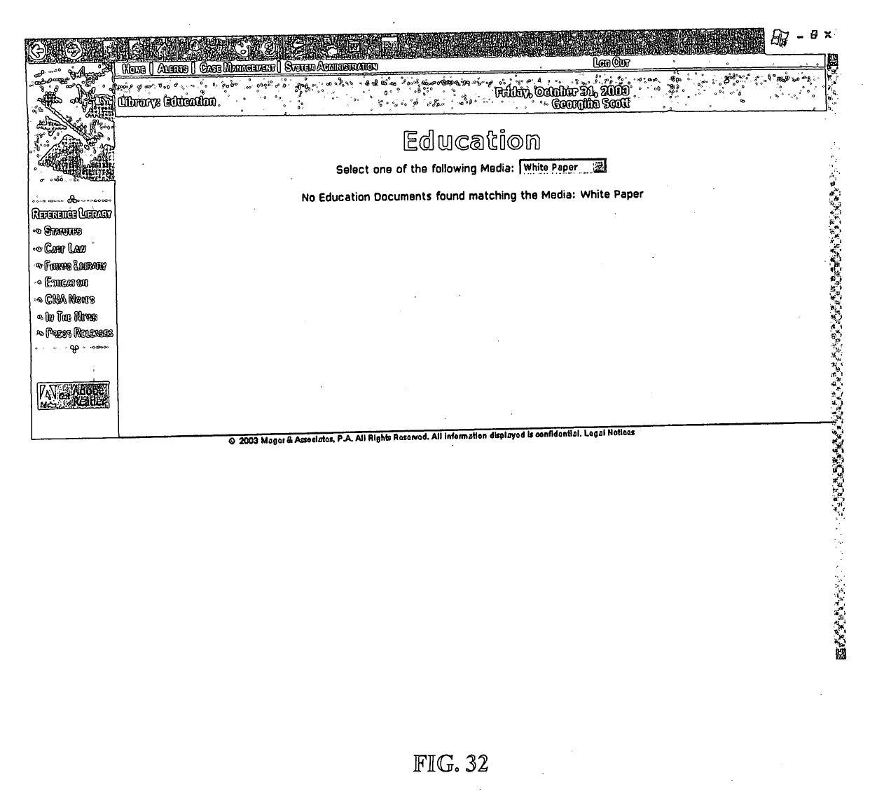

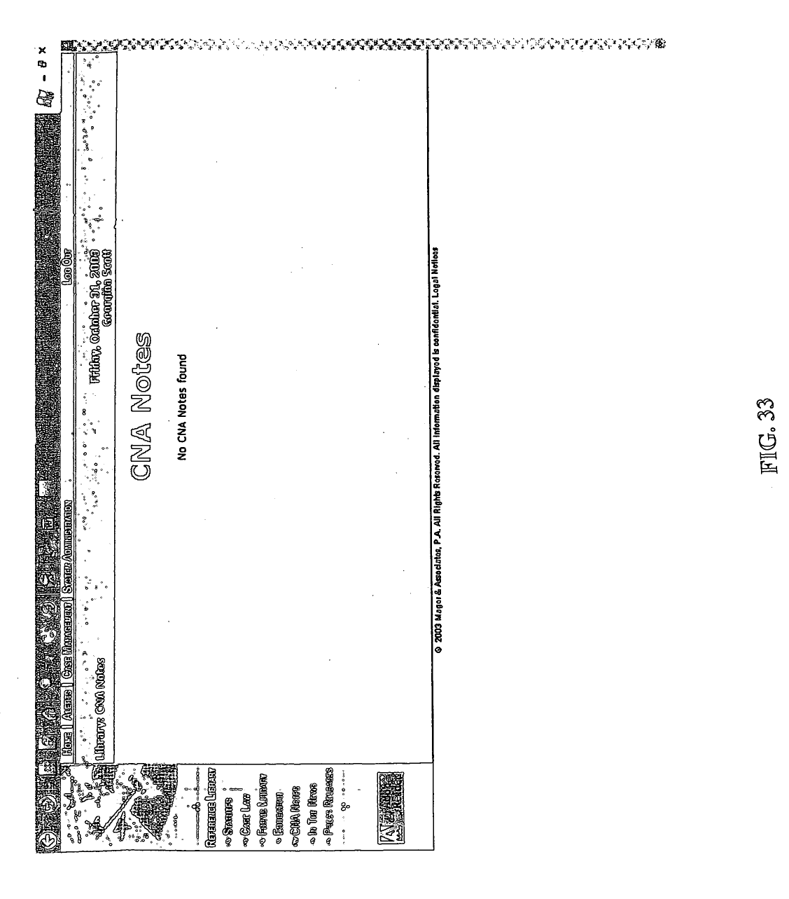

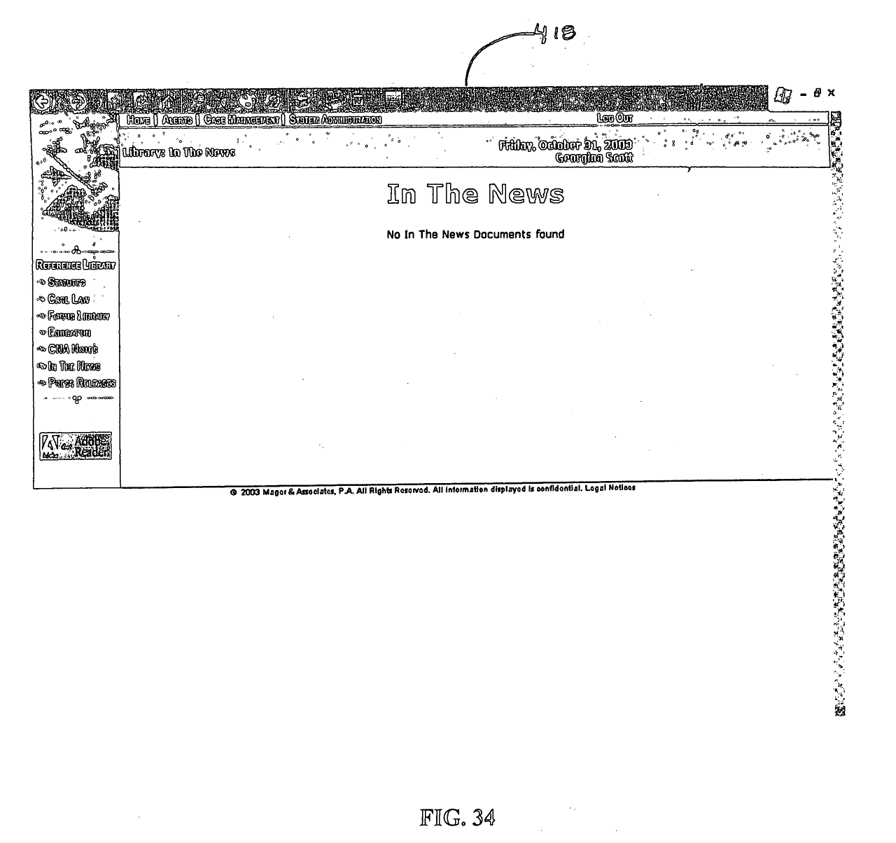

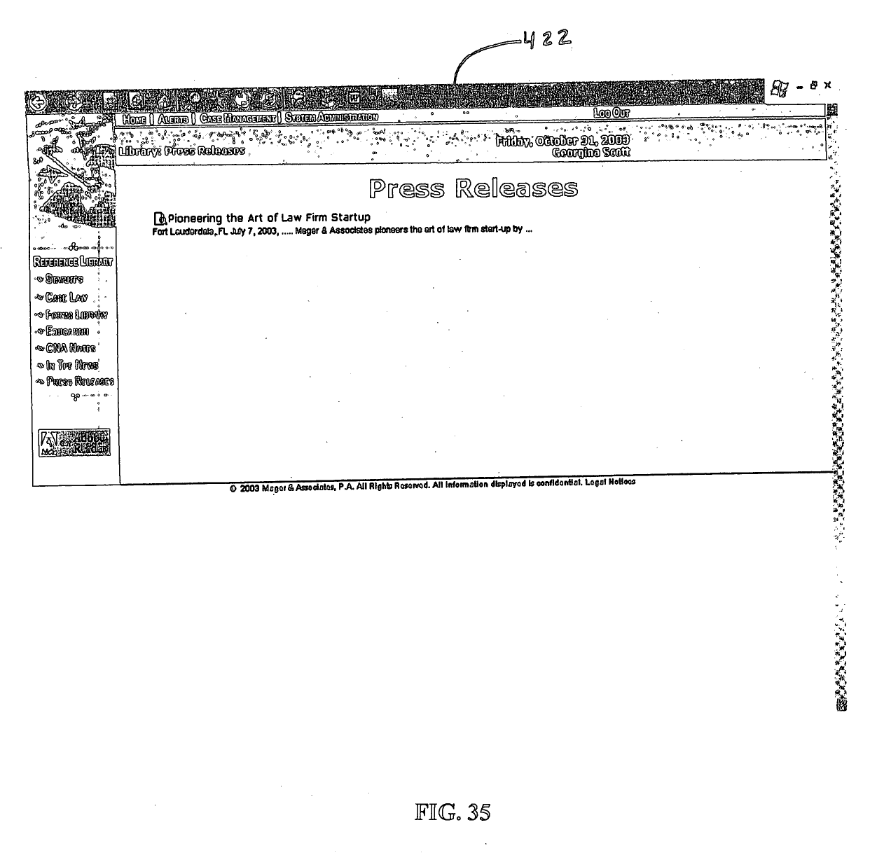

Likewise, selecting the education tab 340 would direct a user to an education page that has educational/training materials (e.g., video, audio, white papers, interactive on-line communication, etc.) organized by subject matter and/or jurisdiction (See, e.g., FIGS. 31 and 32); selecting the notes tab 350 would direct a user to notes provider by another system user (e.g., an insurance company, see e.g., FIG. 33); selecting the news tab 360 would direct a user to news items relating to litigation (See, e.g., screen 418, FIG. 34); and selecting the press releases tab 370 would direct a user to recent press releases related to litigation or insurance company business information (See, e.g., screen 422, FIG. 35).

The system of the invention can also feature other components such as a searching system, an expert witness function, a dictionary function, and a business resources function. The searching system is able to perform searches of the system by keyword or one or more pre-selected criteria [e.g., Region, Status (cancelled, closed, entered, open), claim number, state, type (birth trauma, medical malpractice, nursing home), step (in progress, overdue, completed, all), date (from-to); sort options—case number, state, status, type, date entered]. The search results in a list of cases having the searched for term or terms. The expert witness function of the system provides a user a link to information about potential expert witnesses including, for example, curricula vitae, area(s) of expertise, state, city, first name, last name, prior depositions and court appearances, the outcome of the cases in which the witness participated, comments by other attorneys, and a rating system for attorneys to rate the witness. The dictionary function of the system could include a legal dictionary, a medical dictionary, a compilation of medical abbreviations, medical texts, and other useful materials. The business resources function could have links to information and news about businesses.

In a typical use of the system described in FIGS. 2-35, after an insurance company assigns a new case to a law firm, the insurance company representative posts the new case on the law firm's case list on the system. The law firm then assigns the case to an attorney who then accesses the case list and clicks on an initialize icon to bring up an “initialize case record” page which has fields for entry of case-related information such as claim number, type of case, plaintiff's name, defendant's name, name of insured, insurance company consultant assigned, firm assigned, and attorney assigned. On the page, the attorney clicks on “initialize” button, and a matrix is created based on intake questions.

An attorney signing on to the system would be directed to a home page showing alerts which might include notification of cases with overdue or soon to be due steps, changes in statutes, new case law, news from an insurance company, etc. The attorney might direct the browser to bring up a calendar or case list to check what cases or steps need to be worked on. As an example, if an answer to a complaint is soon due in a case, the attorney would click on the case in the case list to bring up a listing of all steps to be undertaken in the case. The attorney would then click on the “file answer” step to bring up a new page having forms for preparing an answer and links to educational material, statutes, and case law relating to filing an answer. The attorney would then utilize the features of the system to finalize the answer and then file the answer with the court (e.g., by an electronic filing means linked to the system). The attorney would then update the system indicating that the file answer step was completed, and then move on to another task.

An insurance company claims manager signing on to the system would be directed to a home page showing alerts which might also include notification of cases with overdue or soon to be due steps. The claims manager might direct the browser to bring up a case list to check on the status of all cases he is responsible for. If any are overdue, the claims manager might contact the responsible attorney or law firm to inquire as to the reason for the missed deadline. The claims manager might also use the system to analyze whether a case should be settled or litigated based on the attorney's case review that is posted on the system.

Supervising attorneys at a law firm might utilize the system to assess how the junior attorneys are performing. Likewise, managers at an insurance company might use the system to check on how lower level employees are performing.

### OTHER EMBODIMENTS

While the above description contains many specifics, these should not be construed as limitations on the scope of the invention, but rather as examples of preferred embodiments thereof. Many other variations are possible. For example, although the description of the invention focuses on managing litigations from the defense perspective, the invention could also be implemented from a plaintiff perspective. Accordingly, the scope of the invention should be determined not by the embodiments illustrated, but by the appended claims and their legal equivalents.

1. A system for managing a plurality of litigation cases, the system comprising:
a computer program running on a server communicatively connected to a communications network, the computer program comprising instructions for operating the system on the server;
a first network access device operated by a law firm or attorney; and
a second network access device operated by an insurance company or insurance company representative,
wherein the first network access device and the second network access device are communicatively connected to the communications network, and
wherein the system comprises a case management function, a reference library function, and a system administration function.

2. The system of claim 1, further comprising a third network access device operated by a system administrator, the third network access device being communicatively connected to the communications network.

3. The system of claim 1, wherein the plurality of litigation cases are tort cases.

4. The system of claim 3, wherein the law firm or attorney is engaged by the insurance company to provide for the defense of the tort case.

5. The system of claim 1, wherein the communications network is the Internet.

6. The system of claim 1, wherein the case management function comprises a calendar function, a case list function, and a case report function.

7. The system of claim 1, wherein the reference library function comprises means to access statutes, case law, forms, and educational materials.

8. The system of claim 1, wherein the system administration function comprises a means to add, delete, and modify information contained on the system.

9. The system of claim 8, wherein the system administration function further comprises a user selection function, a content selection function, an event viewer function, a categories codes function, a type codes function, a status code function, a matrices function, and a matrix steps function.

10. The system of claim 5, wherein the case management function comprises a calendar function, a case list function, and a case report function; the reference library function comprises means to access statutes, case law, forms, and educational materials; and the system administration function comprises a means to add, delete, and modify information contained on the system.

11. The system of claim 10, wherein the system administration function comprises at least one selected from the group consisting of a user selection function, a content selection function, an event viewer function, a categories codes function, a type codes function, a status code function, a matrices function, and a matrix steps function.

12. A computer program running on a server accessible via a communications network by at least a first network access device operated by a law firm or attorney and a second network access device operated by an insurance company or insurance company representative, the computer program comprising: instructions for causing the server to operate a system for managing a plurality of litigation cases, the system comprising a case management function, a reference library function, and a system administration function.

13. The computer program of claim 12, wherein the server is accessible via the communications network by a third network access device operated by a system administrator.

14. The computer program of claim 12, wherein the communications network is the Internet.

15. The computer program of claim 12, wherein the case management function comprises a calendar function, a case list function, and a case report function.

16. The computer program of claim 12, wherein the reference library function comprises means to access statutes, case law, forms, and educational materials.

17. The computer program of claim 12, wherein the system administration function comprises a means to add, delete, and modify information contained on the system.

18. The computer program of claim 14, wherein the system administration function further comprises a user selection function, a content selection function, an event viewer function, a categories codes function, a type codes function, a status code function, a matrices function, and a matrix steps function.

19. The computer program of claim 12, wherein the case management function comprises a calendar function, a case list function, and a case report function; the reference library function comprises means to access statutes, case law, forms, and educational materials; and the system administration function comprises a means to add, delete, and modify information contained on the system.

20. The computer program of claim 19, wherein the system administration function comprises at least one selected from the group consisting of a user selection function, a content selection function, an event viewer function, a categories codes function, a type codes function, a status code function, a matrices function, and a matrix steps function.

21. A method for managing a plurality of litigation cases, the method comprising the step of: running a computer program on a server, the computer program comprising instructions for operating a system for managing a plurality of litigation cases on the server, the system comprising a case management function, a reference library function, and a system administration function,
wherein the server is accessible via a communications network by at least a first network access device operated by a law firm or attorney and a second network access device operated by an insurance company or insurance company representative.

22. The method of claim 21, wherein the server is accessible via a communications network by a third network access device operated by a system administrator.

23. The method of claim 21, wherein the communications network is the Internet.

24. The method of claim 21, wherein the case management function comprises a calendar function, a case list function, and a case report function.

25. The method of claim 21, wherein the reference library function comprises means to access statutes, case law, forms, and educational materials.

26. The method of claim 21, wherein the system administration function comprises a means to add, delete, and modify information contained on the system.

27. The method of claim 26, wherein the system administration function further comprises a user selection function, a content selection function, an event viewer function, a categories codes function, a type codes function, a status code function, a matrices function, and a matrix steps function.

28. The method of claim 21, wherein the case management function comprises a calendar function, a case list function, and a case report function; the reference library function comprises means to access statutes, case law, forms, and educational materials; and the system administration function comprises a means to add, delete, and modify information contained on the system.

29. The computer program of claim 28, wherein the system administration function comprises at least one selected from the group consisting of a user selection function, a content selection function, an event viewer function, a categories codes function, a type codes function, a status code function, a matrices function, and a matrix steps function.
